(19) United States
(12) Patent Application Publication
(10) Pub. No.: US 2024/0208679 A1
(43) Pub. Date: Jun. 27, 2024

(54) OPTIMIZED PACKING OF POLYGONS INTO A CONTAINER

(71) Applicant: Tencent Technology (Shenzhen) Company Limited, Shenzhen (CN)

(72) Inventors: Kaimo HU, Shenzhen (CN); Shuhuai HUANG, Shenzhen (CN)

(73) Assignee: Tencent Technology (Shenzhen) Company Limited, Shenzhen (CN)

(21) Appl. No.: 18/597,578

(22) Filed: Mar. 6, 2024

Related U.S. Application Data
(63) Continuation of application No. PCT/CN2023/084667, filed on Mar. 29, 2023.

(30) Foreign Application Priority Data
May 25, 2022 (CN) 202210572490.7

(51) Int. Cl. B65B 1/36; B65B 57/14

(52) U.S. Cl. CPC B65B 1/36; B65B 57/14

(57) ABSTRACT

An object processing method includes placing a plurality of objects into a container according to an initial packing algorithm to obtain an initial filling result, wherein the objects and the container are two-dimensional polygons. The method further includes determining a first available space in the container based on the initial filling result, and selecting a first object from the plurality of objects based on the first available space. The method further includes moving the first object to the first available space, and enlarging the first object based on the first available space to obtain an enlarged first object. The method further includes iteratively performing the determining the first available space, the selecting the first object, the moving the first object, and the enlarging the first object until no movable object can be selected from the plurality of objects to generate a repacked container.

### RELATED APPLICATIONS

This application is a continuation of International Application No. PCT/CN2023/084667, filed on Mar. 29, 2023, which claims priority to Chinese Patent Application No. 202210572490.7 filed on May 25, 2022. The disclosures of the prior applications are hereby incorporated by reference in their entirety.

### FIELD OF THE TECHNOLOGY

This disclosure relates to the field of computer technologies, including an object processing method and apparatus, a device, a computer-readable storage medium, and a computer program product.

### BACKGROUND OF THE DISCLOSURE

A polygonal model is a most popular, most important, and most widely supported model representation method in computer graphics. A basic process of two-dimensional packing is as follows: Each polygon is sequentially placed into a container according to a specific rule. Each time a polygon is placed, a region available for placement in the container is updated, and then a next polygon is placed until all polygons are placed into the container or the container is full. FIG. 1A shows an intermediate state of the packing process. Unplaced polygons are shown on the left, and placed polygons and remaining space of the container are shown on the right. The packing problem is widely used in academia, and achievements thereof are also widely used in industry. After a packing result is obtained by using a packing algorithm provided in the related art, there is usually a large gap, leading to a low filling rate of the packing result.

### SUMMARY

Aspects of this disclosure provide an object processing method and apparatus, a computer-readable storage medium, and a computer program product, to increase a filling rate of resource objects in a target container.

In an aspect, an object processing method includes placing a plurality of objects into a container according to an initial packing algorithm to obtain an initial filling result, wherein the objects and the container are two-dimensional polygons. The method further includes determining a first available space in the container based on the initial filling result, and selecting a first object from the plurality of objects based on the first available space. The method further includes moving the first object to the first available space, and enlarging the first object based on the first available space to obtain an enlarged first object. The method further includes iteratively performing the determining the first available space, the selecting the first object, the moving the first object, and the enlarging the first object until no movable object can be selected from the plurality of objects to generate a repacked container.

In an aspect, an object processing apparatus includes processing circuitry configured to place a plurality of objects into a container according to an initial packing algorithm to obtain an initial filling result, wherein the objects and the container are two-dimensional polygons. The processing circuitry is further configured to determine a first available space in the container based on the initial filling result, and select a first object from the plurality of objects based on the first available space. The processing circuitry is further configured to move the first object to the first available space, and enlarge the first object based on the first available space to obtain an enlarged first object. The processing circuitry is further configured to iteratively perform the determining the first available space, the selecting the first object, the moving the first object, and the enlarging the first object until no movable object can be selected from the plurality of objects to generate a repacked container.

In an aspect, a non-transitory computer-readable storage medium storing computer-readable instructions thereon, which, when executed by processing circuitry, cause the processing circuitry to perform an object processing method that includes placing a plurality of objects into a container according to an initial packing algorithm to obtain an initial filling result, wherein the objects and the container are two-dimensional polygons. The method further includes determining a first available space in the container based on the initial filling result, and selecting a first object from the plurality of objects based on the first available space. The method further includes moving the first object to the first available space, and enlarging the first object based on the first available space to obtain an enlarged first object. The method further includes iteratively performing the determining the first available space, the selecting the first object, the moving the first object, and the enlarging the first object until no movable object can be selected from the plurality of objects to generate a repacked container.

During packing, a plurality of to-be-processed resource objects are first placed into a target container to obtain an initial filling result. Then a first target available space, namely, a target gap, in the target container is determined based on the initial filling result. Then a first target object is determined from the plurality of resource objects based on the first target available space, and the first target object is moved to the first target available space. A space occupied by the first target object is smaller than the first target available space. Therefore, after the first target object is moved to the first target available space, the first target object may be further enlarged based on the first target available space to obtain an enlarged first target object, so that the enlarged first target object occupies the first target available space as much as possible. In this way, the space occupied by the first target object before the movement is freed. However, because the space occupied by the first target object is smaller than the first target available space, an available space of the target container is reduced compared with that before the movement. Then a second target available space and a second target object in the target container are determined through iterative processing until no movable target object can be determined from the plurality of resource objects. This can globally optimize a filling result of the target container and minimize an available space to increase a filling rate of the target container.

### BRIEF DESCRIPTION OF THE DRAWINGS

FIG. 1A is a schematic diagram of a packing problem.

FIG. 1B is a schematic diagram of comparison between an axis-aligned bounding box and an optimal bounding box of a polygon.

FIG. 1C is a schematic diagram of Voronoi diagrams corresponding to different types of sites.

FIG. 2 is a schematic architectural diagram of an object processing system 100 according to an aspect of this disclosure.

FIG. 3 is a schematic structural diagram of a second terminal 400 according to an aspect of this disclosure.

FIG. 4 is a schematic implementation flowchart of an object processing method according to an aspect of this disclosure.

FIG. 5 is a schematic implementation flowchart of determining a first target object from a plurality of resource objects according to an aspect of this disclosure.

FIG. 6 is a schematic implementation flowchart of moving a first target object to a first target available space according to an aspect of this disclosure.

FIG. 7 is a schematic diagram of UV island features that need to be pre-calculated according to an aspect of this disclosure.

FIG. 8 is a schematic diagram of a packing result of an object processing method according to an aspect of this disclosure.

FIG. 9 is a schematic diagram of an implementation process of calculating a largest gap according to an aspect of this disclosure.

FIG. 10 is a schematic implementation flowchart of determining a UV island most suitable for movement according to an aspect of this disclosure.

FIG. 11 is a diagram of comparison with optimization effect of an object processing method according to an aspect of this disclosure.

### DETAILED DESCRIPTION

To make the objectives, technical solutions, and advantages of this disclosure clearer, the following describes this disclosure in further detail with reference to the accompanying drawings. The described aspects are not to be considered as a limitation to this disclosure. All other aspects obtained by a person of ordinary skill in the art shall fall within the protection scope of this disclosure.

In the following descriptions, the term “some aspects” describes subsets of all possible aspects, but it can be understood that “some aspects” may be the same subset or different subsets of all the possible aspects, and can be combined with each other without conflict.

In the following descriptions, the terms “first”, “second”, and “third” are merely intended to distinguish between similar objects rather than describe a specific order of objects. It can be understood that the “first”, “second”, and “third” are interchangeable in order in proper circumstances, so that the aspects of this disclosure described herein can be implemented in an order other than the order illustrated or described herein.

Unless otherwise defined, meanings of all technical and scientific terms used in this specification are the same as those usually understood by a person skilled in the art to which this disclosure belongs. The terms used in this specification are merely intended to describe the objectives of the aspects of this disclosure, but are not intended to limit this disclosure.

Before the aspects of this disclosure are further described in detail, terms in the aspects of this disclosure are described, and the following explanations are applicable to the terms in the aspects of this disclosure.

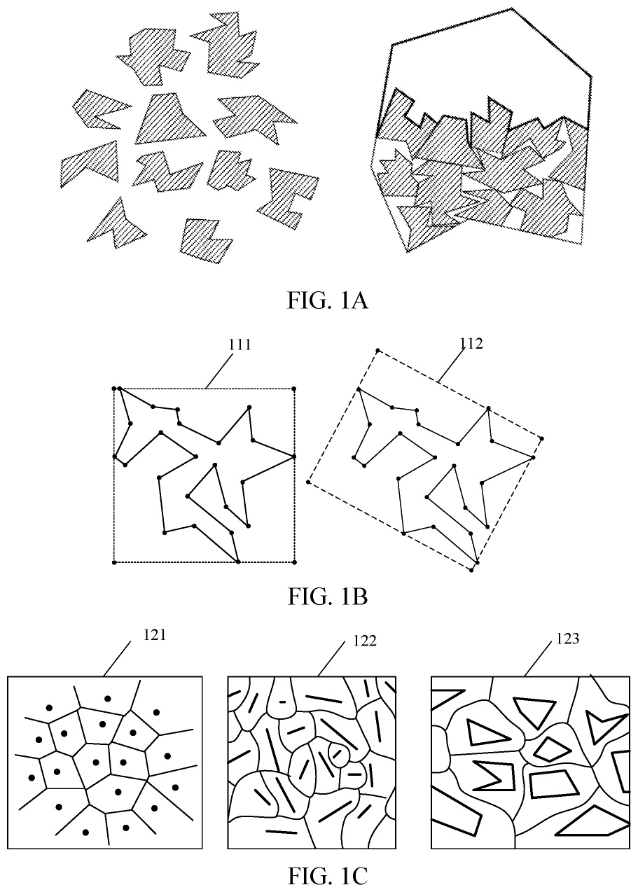

1. Packing problem: In a general sense, a packing problem means arranging a group of regular or irregular two-dimensional or three-dimensional objects in a given regular or irregular container according to a specific rule to achieve a specific purpose. A packing problem in the aspects of this disclosure focuses on packing two-dimensional irregular polygons into a two-dimensional container, as shown in FIG. 1A. In art production terms, a to-be-packed two-dimensional irregular polygon is also referred to as a UV island.

2. A no-fit polygon (NFP) is a polygon formed by a trajectory of a reference point on a boundary of a polygon B when the polygon B slides along an inner wall of another polygon A. The NFP defines a feasible region in which the reference point is placed when the polygon B is packed in a region defined by the polygon A.

3. Minkowski sum: A Minkowski sum of given vector sets A and B is defined as

$$A + B = \{ a + b \vert a ∈ A , b ∈ B \} .$$

4. A genetic algorithm (GM) is a calculation model that simulates natural selection of Darwin's theory of evolution and a biological evolution process of a genetics mechanism, and is a method for searching for an optimal solution by simulating a natural evolution process. The algorithm converts a problem solving process into a process similar to chromogene crossover, mutation, or the like in biological evolution by using mathematics and computer simulation operations. In the case of solving a complex combinatorial optimization problem, this algorithm usually can quickly achieve a good optimization result compared with some related optimization algorithms.

5. Particle swarm optimization (PSO) is a swarm collaboration-based random search algorithm developed by simulating foraging behavior of birds. Through observation of social behavior of animals, PSO finds that social sharing of information in a swarm provides an advantage of evolution, and uses this as a basis for developing an algorithm.

6. Boolean operations: Given a two-dimensional polygon P and Q, the following five Boolean operations are defined:

(1) Intersection: An intersection region of P and Q is retained, and a remaining part is removed. This is expressed as R=P∩Q.

(2) Union: P and Q are combined into a new region. This is expressed as R=P∪Q.

(3) Difference: An intersection part of P and Q is removed from P. This is expressed as R=P\Q.

(4) Symmetric difference: P and Q are combined into a new region, but an intersection part of the two is removed. This is expressed as R=P⊕Q=(P\Q)∪(Q\P).

(5) Complement: Given a universal set S to which P belongs, a complement of P is a part of S that does not belong to P. This is expressed as R=P̅=S\P.

7. A complementary set of a UV island is a complement of a polygon corresponding to the UV island relative to a texture space.

8. A bounding box is an algorithm for finding an optimal bounding space for discrete point sets. A basic idea is to approximately replace a complex geometric object with a slightly large-sized geometry (referred to as a bounding box) with simple characteristics.

9. An axis-aligned bounding box (AABB) (two-dimensional) is a rectangle determined by a coordinate range of all elements in a geometry. The bounding box is a smallest rectangle that can exactly enclose the geometry among all rectangles parallel or perpendicular to a coordinate axis, for example, a rectangle 111 shown on the left in FIG. 1B.

10. An optimal bounding box (OBB) (two-dimensional) is a rectangle with a smallest area among all rectangles that can enclose a geometry, for example, a rectangle 112 shown on the right in FIG. 1B.

11. An AABB tree is a spatial search tree implemented based on a principle of a K-d tree, and each node represents a spatial bounding box of a three-dimensional geometric primitive. The data structure can quickly report whether a queried primitive intersects with a primitive in the tree, and a specific intersection type and intersection location, and the like.

12. A Voronoi diagram, also referred to as a Thiessen polygon, includes continuous polygons constituted by a group of perpendicular bisectors that connect adjacent elements.

13. A Delaunay graph is a dual graph of a Voronoi diagram, and is also referred to as a Delaunay triangulation in a case that elements are points.

14. Voronoi segments: Elements may be extended from points to segments, polygons, or the like to form a Voronoi diagram of segments and polygons. As shown in FIG. 1C, 121 is a Voronoi diagram corresponding to a primitive in which an element is a point; 122 is a Voronoi diagram corresponding to a primitive in which a site is a segment, where a non-bold segment is denoted as a Voronoi segment; and 123 is a Voronoi diagram corresponding to a primitive in which an element is a polygon, where likewise, a non-bold segment in 123 is a Voronoi segment. The aspects of this disclosure focus on a Voronoi diagram corresponding to a primitive in which an element is a polygon.

15. Maximum extensible OBB: A largest rectangle that can be formed in a local gap in which a Voronoi segment is located is referred to as a maximum extensible OBB.

16. Moving a UV island is a process of moving a location of the UV island.

To better understand an object processing method for packing provided in the aspects of this disclosure, a packing algorithm in the related art is first described.

In the related art, a commonly used packing algorithm is a method based on an NFP and a lowest center of gravity. During implementation, a plurality of candidate angles are sequentially determined for each to-be-placed polygon, a plurality of candidate locations are determined based on the candidate angles, and a corresponding polygon is placed based on a candidate location with a highest center of gravity. It is found in practical research that there is a large gap in a container after a polygon is placed according to this packing method, and therefore a filling rate is low.

Based on this, the aspects of this disclosure provide an object processing method and apparatus, a device, a computer-readable storage medium, and a computer program product, to reduce a gap in a container and therefore increase a filling rate. The following describes exemplary application of a computer device provided in the aspects of this disclosure. The computer device provided in the aspects of this disclosure may be implemented as various types of user terminals, for example, a notebook computer, a tablet computer, a desktop computer, a set-top box, or a mobile device (for example, a mobile phone, a portable music player, a personal digital assistant, a dedicated messaging device, or a portable gaming device), or may be implemented as a server. The following describes exemplary application in a case that the device is implemented as a terminal.

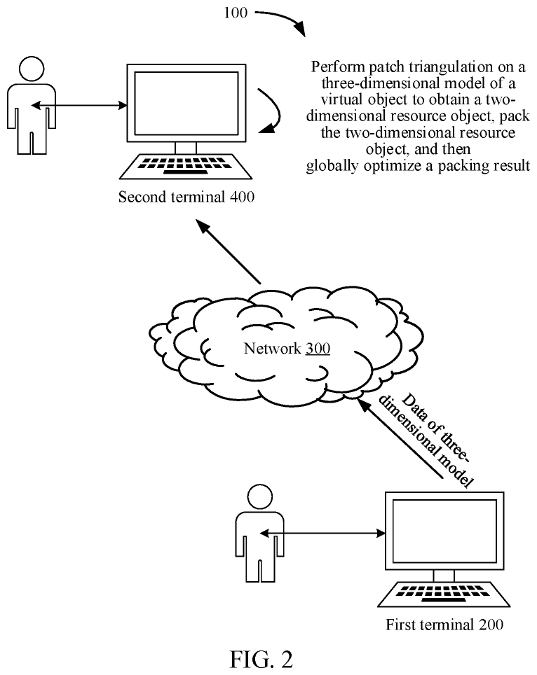

FIG. 2 is a schematic architectural diagram of an object processing system 100 according to an aspect of this disclosure. As shown in FIG. 2, the system includes a first terminal 200, a network 300, and a second terminal 400. The first terminal 200 and the second terminal 400 establish a communication connection through the network. The network 300 may be a wide area network, a local area network, or a combination thereof.

A user may complete a three-dimensional model design for a virtual object by using the first terminal 200. The virtual object may be a virtual object in a game scene, a virtual object in a virtual reality scene or an augmented reality scene, or a virtual object in an animation. For example, the virtual object may be a virtual character, a virtual building, or a virtual plant. A virtual object displayed in a virtual scene is obtained by performing texture mapping on a three-dimensional model of the virtual object by using a texture mapping technology, so that authenticity and vividness of a virtual object displayed on a game screen can be improved. In this aspect of this disclosure, after completing the three-dimensional model design for the virtual object, the first terminal 200 transmits three-dimensional model data to the second terminal 400. The second terminal 400 may perform patch triangulation on the three-dimensional model of the virtual object to obtain a two-dimensional resource object (which may be referred to as a UV island or a polygon in some aspects), and then pack the two-dimensional resource object. During implementation, the two-dimensional resource object may be packed based on a preset packing algorithm to obtain a packing result (corresponding to an initial filling result in other aspects). In this aspect of this disclosure, global optimization may be further performed on the obtained packing result. A largest gap in the initial filling result may be first determined. Then a first target object is determined from a plurality of resource objects, where a space occupied by the first target object is slightly smaller than the largest gap. Then the first target object is moved to the largest gap, and the first target object is enlarged, so that the largest gap is filled with an enlarged first target object as much as possible. Iteration is performed in this way to determine a second target available space and a second target object in a target container, until no movable target object can be determined from the plurality of resource objects. The space occupied by the first target object is smaller than the largest gap, and the first target object is enlarged after being moved, so that a total available space of the container is reduced and a filling rate increases.

In some aspects, the first terminal 200 and the second terminal 400 may be one terminal. To be specific, an object design function and a texture rendering function are completed by one terminal. In some aspects, the second terminal 400 may alternatively obtain a to-be-rendered three-dimensional virtual object from a server. Then the second terminal 400 performs patch triangulation on the three-dimensional virtual object to obtain a plurality of two-dimensional resource objects, and packs and globally optimizes the plurality of resource objects to increase a filling rate.

The server herein may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a CDN, big data, and an artificial intelligence platform. The first terminal 200 and the second terminal 400 may be a smartphone, a tablet computer, a notebook computer, a desktop computer, a smart speaker, a smartwatch, a vehicle-mounted intelligent terminal, or the like, but is not limited thereto. The terminal and the server may be directly or indirectly connected through wired or wireless communication. This is not limited in the aspects of this disclosure.

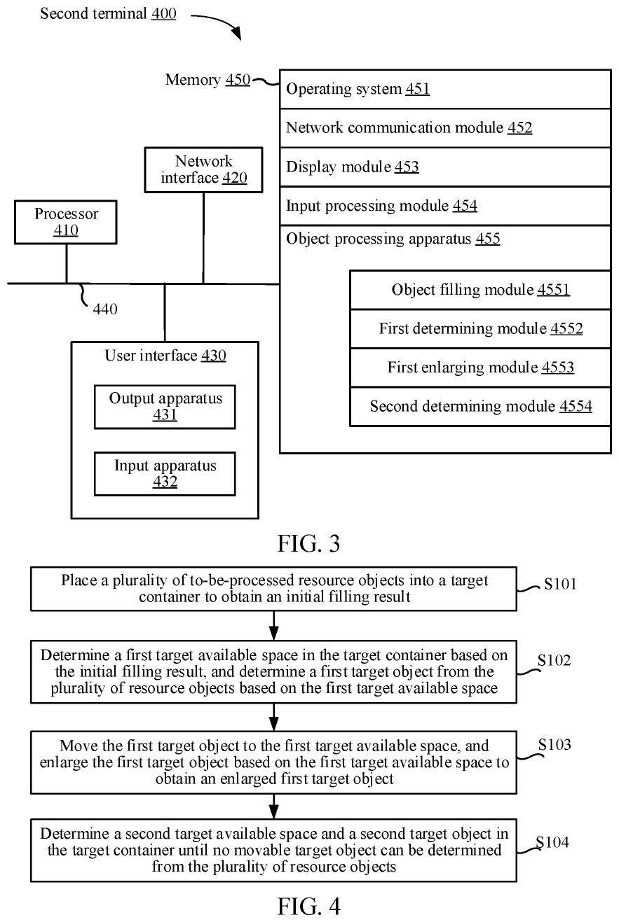

FIG. 3 is a schematic structural diagram of a second terminal 400 according to an aspect of this disclosure. The second terminal 400 shown in FIG. 3 includes at least one processor 410 (e.g., processing circuitry), a memory 450 (e.g., a non-transitory computer-readable storage medium), at least one network interface 420, and a user interface 430. The components of the terminal 400 are coupled together by using a bus system 440. It can be understood that the bus system 440 is configured to implement connection and communication between the components. In addition to a data bus, the bus system 440 further includes a power bus, a control bus, and a state signal bus. However, for ease of clear description, all types of buses in FIG. 3 are marked as the bus system 440.

The processor 410 may be an integrated circuit chip with a signal processing capability, for example, a general-purpose processor, a digital signal processor (DSP), another programmable logic device, a discrete gate or transistor logic device, or a discrete hardware component. The general-purpose processor may be a microprocessor, any related processor, or the like.

The user interface 430 includes one or more output apparatuses 431 capable of displaying media content, including one or more speakers and/or one or more visual display screens. The user interface 430 further includes one or more input apparatuses 432, including user interface components for facilitating user input, for example, a keyboard, a mouse, a microphone, a touch display screen, a camera, or another input button or control.

The memory 450 may be a removable memory, a non-removable memory, or a combination thereof. Exemplary hardware devices include a solid-state memory, a hard disk drive, an optical disc drive, and the like. In some aspects, the memory 450 includes one or more storage devices physically located away from the processor 410.

The memory 450 includes a volatile memory or a non-volatile memory, or may include both a volatile memory and a non-volatile memory. The non-volatile memory may be a read-only memory (ROM). The volatile memory may be a random access memory (RAM). The memory 450 described in this aspect of this disclosure is intended to include any suitable type of memory.

In some aspects, the memory 450 is capable of storing data to support various operations. Examples of the data include a program, a module, and a data structure or a subset or superset thereof. Examples are described below:
an operating system 451, including system programs for processing various basic system services and performing hardware-related tasks, for example, a framework layer, a core library layer, and a driver layer for implementing various basic services and processing hardware-based tasks;
a network communication module 452, configured to reach another computing device through one or more (wired or wireless) network interfaces 420, exemplary network interfaces 420 including Bluetooth, wireless fidelity (Wi-Fi), universal serial bus (USB), and the like;
a display module 453, configured to display information by using one or more output apparatuses 431 (for example, a display screen or a speaker) associated with the user interface 430 (for example, a user interface for operating a peripheral device and displaying content and information); and
an input processing module 454, configured to detect one or more user inputs or interactions from one or more input apparatuses 432 and translate the detected inputs or interactions.

In some aspects, the apparatus provided in the aspects of this disclosure may be implemented by using software. FIG. 3 shows an object processing apparatus 455 stored in the memory 450. The object processing apparatus may be software in a form of a program or plug-in, and includes the following software modules: an object filling module 4551, a first determining module 4552, a first enlarging module 4553, and a second determining module 4554. These modules are logical modules, and therefore may be flexibly combined or further split based on implemented functions. Functions of the modules are described below.

In some other aspects, the apparatus provided in the aspects of this disclosure may be implemented by using hardware. In an example, the apparatus provided in the aspects of this disclosure may be a processor in a form of a hardware decoding processor, and is programmed to perform the object processing method provided in the aspects of this disclosure. For example, the processor in the form of the hardware decoding processor may be one or more application-specific integrated circuits (ASICs), DSPs, programmable logic devices (PLDs), complex programmable logic devices (CPLDs), field programmable gate arrays (FPGAs), or other electronic elements.

The object processing method provided in the aspects of this disclosure is described with reference to the exemplary application and implementation of the terminal provided in the aspects of this disclosure. The object processing method provided in the aspects of this disclosure may be applied to a map rendering scenario.

FIG. 4 is a schematic implementation flowchart of an object processing method according to an aspect of this disclosure. The method is described with reference to steps shown in FIG. 4.

Step S101: Place a plurality of to-be-processed resource objects into a target container to obtain an initial filling result. For example, a plurality of objects are placed into a container according to an initial packing algorithm to obtain an initial filling result. The objects and the container are two-dimensional polygons.

Herein, the plurality of resource objects may be two or more resource objects. In this aspect of this disclosure, the resource object may be a two-dimensional polygon (hereinafter referred to as a polygon) obtained through triangulation on a three-dimensional model of a virtual object. The polygon may be a polygon with or without a hole. In some aspects, the resource object may be a UV island in the game production industry. The UV island is essentially the foregoing polygon. In addition, the resource object may alternatively be obtained by expanding and partitioning an actual object. The target container is used for carrying the resource object, and the target container may also be a polygonal two-dimensional object.

During practical application, in an example, the plurality of to-be-processed resource objects may be sequentially placed into the target container by using a preset packing algorithm to obtain the initial filling result. For example, a packing algorithm based on an NFP and a genetic algorithm or an automatic packing algorithm based on an NFP and a principle of a lowest center of gravity may be used. In some aspects, the initial filling result may also be referred to as a packing result. The initial filling result may include locations of center points of the resource objects, and may further include location information of outer contour vertices of the resource objects, an available location in the target container, or the like.

Step S102: Determine a first target available space in the target container based on the initial filling result, and determine a first target object from the plurality of resource objects based on the first target available space. For example, a first available space in the container is determined based on the initial filling result, and a first object is selected from the plurality of objects based on the first available space.

An available space in the target container may be understood as a space not occupied by a resource object, and may also be referred to as a gap in some aspects. In this aspect of this disclosure, the first target available space is a largest gap in the target container. In some aspects, outer contour information of the resource objects in the target container may be determined based on the initial filling result. After the outer contour information of the resource objects is obtained, contour information of available spaces in the target container can be determined. Then Voronoi diagrams for the available spaces are constructed, and the largest gap, namely, the first target available space, in the target container is determined based on the Voronoi diagrams. After the first target available space is determined, the first target object occupying a space smaller than the first target available space needs to be selected from the plurality of resource objects. In the case of determining the first target object, a scaling ratio of the first target object needs to be greater than a specific ratio threshold, and the first target object is also a resource object corresponding to a smallest ratio greater than the ratio threshold. This can ensure that an available space is reduced but a scaling ratio of a resource object is not excessively large, to ensure that the resource objects are uniformly enlarged without distortion.

Step S103: Move the first target object to the first target available space, and enlarge the first target object based on the first target available space to obtain an enlarged first target object. For example, the first object is moved to the first available space, and the first object is enlarged based on the first available space to obtain an enlarged first object.

In some aspects, a center point of the first target object may be moved to a center point of the first target available space. Then the first target object is rotated so that the first target object is fully located in the first target available space. Then the first target object is enlarged so that the first target object is enlarged as much as possible without going beyond the first target available space. Because the space occupied by the first target object is smaller than the first target available space, an available space of the target container can be reduced after the first target object is moved to the first target available space and enlarged, to increase a filling rate of the target container.

Step S104: Determine a second target available space and a second target object in the target container until no movable target object can be determined from the plurality of resource objects. For example, the determining the first available space, the selecting the first object, the moving the first object, and the enlarging the first object are iteratively performed until no movable object can be selected from the plurality of objects to generate a repacked container.

After the first target object is moved to the first target available space, the foregoing step is iteratively performed to determine a largest second target available space in the target container and a second target object to be moved to the second target available space, the second target object is moved to the second target available space, and then the second target object is enlarged to further reduce an available space in the target container and increase a filling rate, until no movable target object can be determined from the resource objects. In this way, global optimization on the target container is completed.

In the object processing method provided in this aspect of this disclosure, the plurality of to-be-processed resource objects are first placed into the target container to obtain the initial filling result. Then the first target available space, namely, a target gap, in the target container is determined based on the initial filling result. Then the first target object is determined from the plurality of resource objects based on the first target available space, and the first target object is moved to the first target available space. The space occupied by the first target object is smaller than the first target available space. Therefore, after the first target object is moved to the first target available space, the first target object may be further enlarged based on the first target available space to obtain the enlarged first target object, so that the enlarged first target object occupies the first target available space as much as possible. In this way, the space occupied by the first target object before the movement is freed. However, because the space occupied by the first target object is smaller than the first target available space, an available space of the target container is reduced compared with that before the movement. Then the second target available space and the second target object in the target container are determined through iterative processing until no movable target object can be determined from the plurality of resource objects. This can globally optimize a filling result of the target container and minimize an available space to increase a filling rate of the target container and improve memory utilization of a computer device. In addition, because the filling rate of the target container is increased and the resource objects are enlarged, a resolution of texture mapping can be increased.

In some aspects, after step S101, an inclusion relationship between different resource objects may be further determined by using step S201 to step S204. The steps are described below.

Step S201: Obtain information of holes of an i^{th} resource object.

i=1, 2, . . . , N, N is the total number of resource objects, and N is a positive integer. In this aspect of this disclosure, the resource object may be a two-dimensional polygon. In a case that a two-dimensional polygon includes another polygon, the included polygon may be referred to as a hole of the two-dimensional polygon. The information of the holes of the resource object may include names of vertices on the holes, a vertex location, and a connection relationship between vertices.

Step S202: Randomly determine a reference point from an outer boundary of a j^{th} resource object, and determine whether the reference point is located in a hole of the i^{th} resource object.

The reference point is a random point located on the outer boundary of the j^{th} resource object. j=1, 2, . . . , N, and i is not equal to j. In an example, whether the reference point is located in a hole of the i^{th} resource object may be checked by using a library function provided by the CGAL. During implementation, whether the reference point is located in each hole of the i^{th} resource object is sequentially determined. In a case that the reference point is located in none of holes of the i^{th} resource object, it is determined that the reference point is not located in a hole of the i^{th} resource object, and in this case, step S204 is performed. In a case that the reference point is located in a specific hole of the i^{th} resource object, it is determined that the reference point is located in a hole of the i^{th} resource object, and in this case, step S203 is performed.

Step S203: Determine that the i^{th} resource object includes the j^{th} resource object, and update inclusion relationship information of the i^{th} resource object and the j^{th} resource object.

In this aspect of this disclosure, inclusion relationship information of each resource object may include a first object set and a second object set. The first object set includes an object identifier of a resource object included in the resource object. The second object set includes an object identifier of another resource object including the resource object. In the case of determining that the i^{th} resource object includes the j^{th} resource object, an object identifier of the j^{th} resource object needs to be added to a first object set of the i^{th} resource object, and an object identifier of the i^{th} resource object needs to be added to a second object set of the j^{th} resource object.

Step S204: Determine that the i^{th} resource object does not include the j^{th} resource object.

In a packing problem for some applications, some resource objects in an obtained initial filling result may be located in holes of some other resource objects. In this case, in a case that a resource object that needs to be moved includes another resource object, the another resource object included in a hole of the resource object needs to be moved synchronously. Therefore, before packing is optimized, step S201 to step S204 may be performed to determine an inclusion relationship between different resource objects. In this way, during optimization of a packing result, resource objects having an inclusion relationship can be moved synchronously based on the inclusion relationship between the resource objects, to improve optimization efficiency.

In some aspects, attitude information of the resource object may be further determined by using step S211 to step S217. The attitude information can represent whether the resource object is in a horizontal and vertical state. The steps are described below.

Step S211: Obtain segments included in the i^{th} resource object and lengths of the segments.

In some aspects, the segments included in the i^{th} resource object and the lengths of the segments may be obtained based on vertex information of the i^{th} resource object. The vertex information of the i^{th} resource object includes vertex coordinates of each vertex and other vertices connected to the vertex. Assuming that a vertex 1 is connected to a vertex 2 and a vertex 3, a length of a segment 12 may be determined based on vertex coordinates of the vertex 1 and vertex coordinates of the vertex 2, and a length of a segment 13 may be determined based on the vertex coordinates of the vertex 1 and vertex coordinates of the vertex 3.

Step S212: Determine a target segment based on endpoint information of the segments.

Endpoint information of a segment includes coordinates of two endpoints of the segment. In some aspects, a first coordinate difference between two endpoints of each segment in a horizontal direction and a second coordinate difference between the two endpoints of the segment in a vertical direction are determined based on coordinates of the two endpoints of the segment, and a segment with a first coordinate difference less than a preset difference threshold or with a second coordinate difference less than the difference threshold is determined as the target segment. For example, coordinates of two endpoints are (x1, y1) and (x2, y2) respectively. In this case, a first coordinate difference between the two endpoints in the horizontal direction is |y1−y2|, where |⋅| indicates to take an absolute value; and a second coordinate difference between the two endpoints in the vertical direction is |x1−x2|.

A first coordinate difference between two endpoints of the target segment in the horizontal direction is less than a preset difference threshold, or a second coordinate difference between the two endpoints of the target segment in the vertical direction is less than the difference threshold. In a case that the first coordinate difference between the two endpoints of the target segment in the horizontal direction is less than the difference threshold, it indicates that the target segment is basically in a horizontal attitude. In a case that the second coordinate difference between the two endpoints of the target segment in the vertical direction is less than the difference threshold, it indicates that the target segment is basically in a vertical attitude.

Step S213: Determine a first total length of the i^{th} resource object based on the lengths of the segments.

During implementation, the lengths of the segments are summed to obtain the first total length of the i^{th} resource object.

Step S214: Determine a second total length of the i^{th} resource object based on a length of the target segment.

During implementation, lengths of target segments are summed to obtain the second total length of the i^{th} resource object.

Step S215: Determine whether a ratio of the second total length to the first total length is greater than a preset ratio threshold.

In a case that the ratio of the second total length to the first total length is greater than the preset ratio threshold, step S216 is performed. In a case that the ratio is less than or equal to the ratio threshold, step S217 is performed.

Step S216: Determine that attitude information of the i^{th} resource object is a first attitude.

In a case that the ratio of the second total length to the first total length is greater than the ratio threshold, it indicates that a ratio of segments in a horizontal state or a vertical state to the total number of segments in the i^{th} resource object exceeds the ratio threshold. In this case, it is determined that the attitude information of the i^{th} resource object is the first attitude. The first attitude represents that the i^{th} resource object is in a horizontal and vertical attitude.

Step S217: Determine that attitude information of the i^{th} resource object is a second attitude.

In a case that the ratio of the second total length to the first total length is less than or equal to the ratio threshold, it indicates that a ratio of segments in a horizontal state or a vertical state to the total number of segments in the i^{th} resource object does not exceed the ratio threshold. In this case, it is determined that the attitude information of the i^{th} resource object is the second attitude. The second attitude represents that the i^{th} resource object is in a vertical attitude.

Attitude information of the resource objects may be determined by using step S211 to step S217. Attitude information of a resource object can represent whether the resource object is in a horizontal and vertical state. In some application scenarios, for a resource object in a horizontal and vertical attitude, this attitude characteristic needs to be retained during location optimization. In this case, a resource object mainly including horizontal and vertical segments is allowed to rotate only by an integer multiple of 90° during location optimization. Therefore, the attitude information of the resource objects needs to be determined by using step S211 to step S217 and saved to provide reference for subsequently determining a rotational angle by an algorithm.

In some aspects, the “determining a first target available space in the target container based on the initial filling result” in step S102 may be implemented by the following step S1021 to step S1024. The steps are described below.

Step S1021: Obtain outer contour information of the plurality of resource objects, and determine a complementary space of the outer contour information of the plurality of resource objects relative to the target container based on the initial filling result.

To obtain outer contour information of a resource object, during implementation, each edge (namely, each segment) on the resource object and two adjacent surfaces of each edge may be obtained first, and then whether the adjacent surfaces of each edge are located inside the resource object may be determined. In a case that both adjacent surfaces of an edge are located inside the resource object, it is determined that the edge is an inner edge; otherwise, it is determined that the edge is an outer boundary. Outer boundaries of a resource object are connected to form an outer contour of the resource object. Outer contours of the resource objects can represent locations and spaces occupied by the resource objects in the target container. In addition, in a case that location information of the target container and the outer contour information of the resource objects placed in the target container are known, the complementary space of the outer contour information of the plurality of resource objects relative to the target container can be determined by using a library function provided by the CGAL for determining a complementary space. The complementary space represents a space not occupied by a resource object in the target container.

Step S1022: Determine a Voronoi diagram of the complementary space, and obtain Voronoi segments in the Voronoi diagram.

In some aspects, the Voronoi diagram of the complementary space may be determined by using a library function provided by the CGAL for determining a Voronoi diagram. After the Voronoi diagram of the complementary space is determined, segments constituting the Voronoi diagram are obtained to obtain the Voronoi segments.

Step S1023: Determine Voronoi bounding boxes corresponding to the Voronoi segments.

In an example, the Voronoi bounding boxes corresponding to the Voronoi segments may be determined by using a spatial search tree method. In this aspect of this disclosure, the Voronoi bounding box may be a maximum extensible bounding box. During practical application, rays may be first respectively emitted upward and downward along a direction perpendicular to a current Voronoi segment S, and then shortest intersection points of an upward ray and a downward ray are respectively calculated, and distances a and b from the intersection points to S are recorded. Then a segment T that passes through a midpoint of S, is perpendicular to S, and has an upward length a and a downward length b is constructed. Rays are respectively emitted to the left and to the right along a direction perpendicular to the segment T (namely, a direction of a straight line to which S belongs), and then shortest intersection points of the two rays are calculated, and distances c and d from the intersection points to T are recorded. Finally, a rectangle with a length a in an up direction, a length b in a down direction, a length c in a left direction, and a length d in a right direction is constructed based on the midpoint of S. The rectangle is a maximum extensible OBB corresponding to the current Voronoi segment S.

Step S1024: Determine a Voronoi bounding box with a largest area as the first target available space in the target container.

A Voronoi bounding box is a rectangular bounding box, and in the case of determining a Voronoi bounding box of a Voronoi segment in step S1023, lengths of two adjacent edges of the Voronoi bounding box are (a+b) and (c+d). Therefore, it can be learned that an area of the Voronoi bounding box is (a+b)×(c+d). In a case that a Voronoi bounding box of each Voronoi segment is obtained, an area of the Voronoi bounding box can be determined based on lengths of two adjacent edges of the Voronoi bounding box. In step S1024, the Voronoi bounding box with the largest area is determined as the first target available space in the target container.

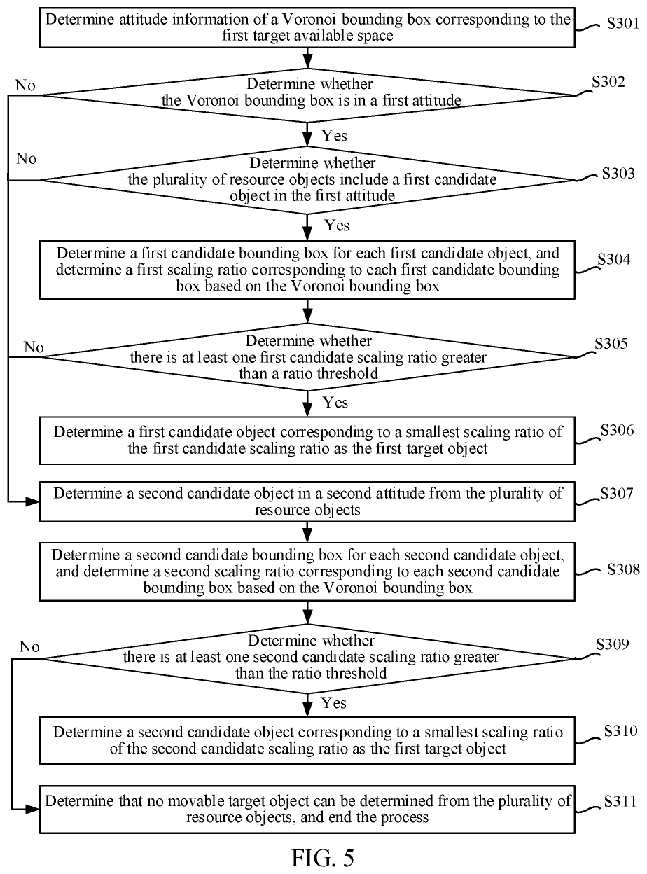

In some aspects, the “determining a first target object from the plurality of resource objects based on the first target available space” in step S102 may be implemented by step S301 to step S311 shown in FIG. 5. The steps are described below with reference to FIG. 5.

Step S301: Determine attitude information of a Voronoi bounding box corresponding to the first target available space.

One of two adjacent edges of a Voronoi bounding box is perpendicular to a Voronoi segment corresponding to the Voronoi bounding box, and the other is parallel to the Voronoi segment corresponding to the Voronoi bounding box. Therefore, during implementation, the determining attitude information of a Voronoi bounding box corresponding to the first target available space may be implemented by determining an attitude of a Voronoi segment corresponding to the Voronoi bounding box. In a case that a coordinate difference between two endpoints of the Voronoi segment in the horizontal direction is less than a preset difference threshold or a coordinate difference between the two endpoints of the Voronoi segment in the vertical direction is less than the preset difference threshold, it indicates that the Voronoi segment is horizontal or vertical. Therefore, correspondingly, an attitude of the Voronoi bounding box is the first attitude, to be specific, the first attitude is a horizontal and vertical attitude.

Step S302: Determine whether the Voronoi bounding box is in the first attitude.

In a case that the Voronoi bounding box is in the first attitude, step S303 is performed to preferentially select a resource object also in the first attitude as a first candidate object. In a case that the Voronoi bounding box is in the second attitude, step S307 is performed to select a resource object in the second attitude as a second candidate object.

Step S303: Determine whether the plurality of resource objects include a first candidate object in the first attitude.

In some aspects, the attitude information and inclusion relationship information of the resource objects are first obtained, and then whether the plurality of resource objects include a first candidate object that is in the first attitude and that is not included in other resource objects is determined based on the attitude information and the inclusion information of the resource objects. In the case of determining that there is at least one first candidate object, step S304 is performed. In the case of determining that there is no first candidate object, step S307 is performed.

In a case that a resource object is included in another object, the resource object does not occupy an additional space in a strict sense, and no space is freed after the resource object is moved out. Therefore, in the case of determining whether there is a first candidate object in this step, whether a resource object is in the first attitude needs to be determined, and whether the resource object is included in another resource object also needs to be determined.

Step S304: Determine a first candidate bounding box for each first candidate object, and determine a first scaling ratio corresponding to each first candidate bounding box based on the Voronoi bounding box.

The first candidate bounding box may be an optimal bounding box, to be specific, a smallest rectangular bounding box that can enclose the first candidate object. In a case that a first candidate bounding box and a Voronoi bounding box of each first candidate object are known, a length scaling ratio corresponding to a long edge and a width scaling ratio corresponding to a short edge may be determined based on a length and a width of each first candidate bounding box and a length and a width of the Voronoi bounding box, and a smaller one of the length scaling ratio and the width scaling ratio is determined as a first scaling ratio of the first candidate bounding box.

Step S305: Determine whether there is at least one first candidate scaling ratio greater than a preset ratio threshold.

The ratio threshold is a real number greater than 1. In a case that there is at least one first candidate scaling ratio greater than the preset ratio threshold, it indicates that there is a first candidate object occupying a space smaller than the first target available space. In this case, step S306 is performed. In a case that there is no candidate scaling ratio greater than the ratio threshold, step S307 is performed.

Step S306: Determine a first candidate object corresponding to a smallest scaling ratio of the first candidate scaling ratio as the first target object.

During practical application, in a case that a condition for selecting a target object is only being greater than the ratio threshold, an algorithm falls into a dead loop, or operation efficiency is excessively low. Therefore, a first candidate object corresponding to a smallest scaling ratio greater than the ratio threshold may be further determined as the first target object. This can enlarge the plurality of resource objects as uniformly as possible during location optimization, and avoid a problem that a few resource objects are enlarged at a large ratio and consequently, sizes of most resource objects remain unchanged, causing distortion.

Step S307: Determine a second candidate object in the second attitude from the plurality of resource objects.

The attitude information of the resource objects is determined by using the foregoing step S211 to step S217. In this step, a resource object whose attitude information is the second attitude is determined as the second candidate object.

Step S308: Determine a second candidate bounding box for each second candidate object, and determine a second scaling ratio corresponding to each second candidate bounding box based on the Voronoi bounding box.

An implementation process of this step is similar to that of step S304. During practical implementation, refer to the implementation process of step S304.

Step S309: Determine whether there is at least one second candidate scaling ratio greater than a ratio threshold.

In a case that there is at least one second candidate scaling ratio greater than a preset ratio threshold, step S310 is performed. In a case that there is no second candidate scaling ratio greater than the preset ratio threshold, step S311 is performed.

Step S310: Determine a second candidate object corresponding to a smallest scaling ratio of the second candidate scaling ratio as the first target object.

The second candidate object corresponding to the smallest scaling ratio of the second candidate scaling ratio is a resource object that occupies a space smaller than the first target available space and closest to the first target available space.

Step S311: Determine that no movable target object can be determined from the plurality of resource objects, and end the process.

In the case of determining the first target object from the plurality of resource objects based on the first target available space, in the foregoing step S301 to step S311, the attitude information of the Voronoi bounding box corresponding to the first target available space is first determined. For the first target available space in the first attitude (horizontal and vertical), a resource object also in the first attitude may be preferentially determined as a candidate object. Then a resource object corresponding to a smallest ratio greater than the ratio threshold is further selected as the first target object based on a scaling ratio corresponding to the candidate object. This can not only ensure high processing efficiency, but also enlarge resource objects uniformly. In a case that no resource object that is in the first attitude and whose scaling ratio meets the condition is selected for the first target available space in the first attitude (horizontal and vertical), a resource object whose scaling ratio meets the condition may be selected from resource objects in the second attitude. This can increase a hit rate of a to-be-moved target object. However, for the first target available space in the second attitude, a first target resource object whose scaling ratio meets the condition can be selected only from resource objects also in the second attitude, but not from resource objects in the first attitude. In other words, a resource object in the first attitude can be placed only in an available space in the first attitude, to ensure that a resource object in a horizontal and vertical attitude can still be in the horizontal and vertical attitude after being moved. However, a resource object in the second attitude may be placed in a space in the first attitude or in a space in the second attitude, to increase a hit rate of a to-be-moved target object and increase object processing efficiency.

In some aspects, the “determining attitude information of a Voronoi bounding box corresponding to the first target available space” in step S301 may be implemented by the following step S3011 to step S3015. The steps are described below.

Step S3011: Obtain first coordinate information of a first endpoint of a Voronoi segment corresponding to the Voronoi bounding box and second coordinate information of a second endpoint.

The first coordinate information includes a first horizontal coordinate value of the first endpoint in the horizontal direction and a first vertical coordinate value in the vertical direction. The second coordinate information includes a second horizontal coordinate value of the second endpoint in the horizontal direction and a second vertical coordinate value in the vertical direction. For example, first coordinate information of a first endpoint of a Voronoi segment A is (34, 58), and second coordinate information of a second endpoint may be (38.2, 108); and first coordinate information of a first endpoint of a Voronoi segment B is (58, 99), and second coordinate information of a second endpoint is (58, 129).

Step S3012: Determine, based on the first coordinate information and the second coordinate information, a first coordinate difference between the first endpoint and the second endpoint in the horizontal direction, and determine a second coordinate difference between the first endpoint and the second endpoint in the vertical direction.

In an example, an absolute value of a difference between the first vertical coordinate value in the first coordinate information and the second vertical coordinate value in the second coordinate information may be determined as the first coordinate difference, and an absolute value of a difference between the first horizontal coordinate value in the first coordinate information and the second horizontal coordinate value in the second coordinate information is determined as the second coordinate difference.

With reference to the foregoing example, a first coordinate difference of the Voronoi segment A is 4.2, and a second coordinate difference is 50; and a first coordinate difference of the Voronoi segment B is 0, and a second coordinate difference is 30.

Step S3013: Determine whether the first coordinate difference or the second coordinate difference of the Voronoi segment is less than a preset difference threshold.

The difference threshold may be 0 or a real number close to 0, for example, 0.1 or 0.05. In a case that the first coordinate difference is less than the preset difference threshold, it indicates that coordinates of the two endpoints of the Voronoi segment in the horizontal direction are almost the same, that is, the Voronoi segment is in the horizontal direction. In a case that the second coordinate difference is less than the difference threshold, it indicates that coordinates of the two endpoints of the Voronoi segment in the vertical direction are almost the same, that is, the Voronoi segment is in the vertical direction. Therefore, in a case that the first coordinate difference is less than the difference threshold or the second coordinate difference is less than the difference threshold, step S3014 is performed; or in a case that the first coordinate difference is greater than or equal to the difference threshold and the second coordinate difference is greater than or equal to the difference threshold, step S3015 is performed.

Step S3014: Determine that the attitude information of the Voronoi bounding box is the Voronoi bounding box being in the first attitude.

Step S3015: Determine that the attitude information of the Voronoi bounding box is the Voronoi bounding box being in the second attitude.

One edge of two adjacent edges of a Voronoi bounding box is parallel to a Voronoi segment corresponding to the Voronoi bounding box, and the other edge is perpendicular to the Voronoi segment. Therefore, in the foregoing step S3011 to step S3015, in the case of determining the attitude information of the Voronoi bounding box, an attitude of the Voronoi segment corresponding to the Voronoi bounding box may be determined by determining the first coordinate difference and the second coordinate difference of the two endpoints of the Voronoi segment, and the attitude information of the Voronoi bounding box is determined by using the attitude of the Voronoi segment, to provide a data basis for subsequently determining a target object corresponding to a target available space.

In some aspects, the “determining a first scaling ratio corresponding to each first candidate bounding box based on a Voronoi bounding box” in step S304 may be implemented by the following step S3041 to step S3044.

Step S3041: Obtain a first length and a first width of the Voronoi bounding box, and obtain a second length and a second width of the first candidate bounding box.

It is assumed that the first length and the first width of the Voronoi bounding box are 100 and 80 respectively, a second length and a second width of a first candidate bounding box A are 50 and 35 respectively, a second length and a second width of a first candidate bounding box B are 80 and 40 respectively, and a second length and a second width of a first candidate bounding box C are 200 and 120 respectively.

Step S3042: Determine a quotient of the first length and the second length as a length scaling ratio.

A length scaling ratio of the first candidate bounding box A is 2, a length scaling ratio of the first candidate bounding box B is 1.25, and a length scaling ratio of the first candidate bounding box C is 0.5.

Step S3043: Determine a quotient of the first width and the second width as a width scaling ratio.

A width scaling ratio of the first candidate bounding box A is 2.3, a width scaling ratio of the first candidate bounding box B is 2, and a width scaling ratio of the first candidate bounding box C is 0.67.

Step S3044: Determine a smaller one of the length scaling ratio and the width scaling ratio as the first scaling ratio corresponding to the first candidate bounding box.

With reference to the foregoing ratios, because the length scaling ratio and the width scaling ratio of the first candidate bounding box A are 2 and 2.3 respectively, a smaller one of the two ratios is 2, to be specific, a first scaling ratio corresponding to the first candidate bounding box is 2; because the length scaling ratio and the width scaling ratio of the first candidate bounding box B are 1.25 and 2 respectively, a smaller one of the two ratios is 1.25, to be specific, a first scaling ratio corresponding to the first candidate bounding box is 1.25; and because the length scaling ratio and the width scaling ratio of the first candidate bounding box C are 0.5 and 0.67 respectively, a smaller one of the two ratios is 0.5, to be specific, a scaling ratio of the first candidate bounding box C is 0.5.

In the case of determining the scaling ratio of each first candidate object, in the foregoing step S3041 to step S3044, the length scaling ratio and the width scaling ratio need to be determined based on size information of the Voronoi bounding box and size information of each first candidate object, and a smaller one of the two ratios is used as a final first scaling ratio. This can ensure that a resource object does not go beyond a range of a target available space when being enlarged based on the first scaling ratio, and therefore avoid overlapping between resource objects.

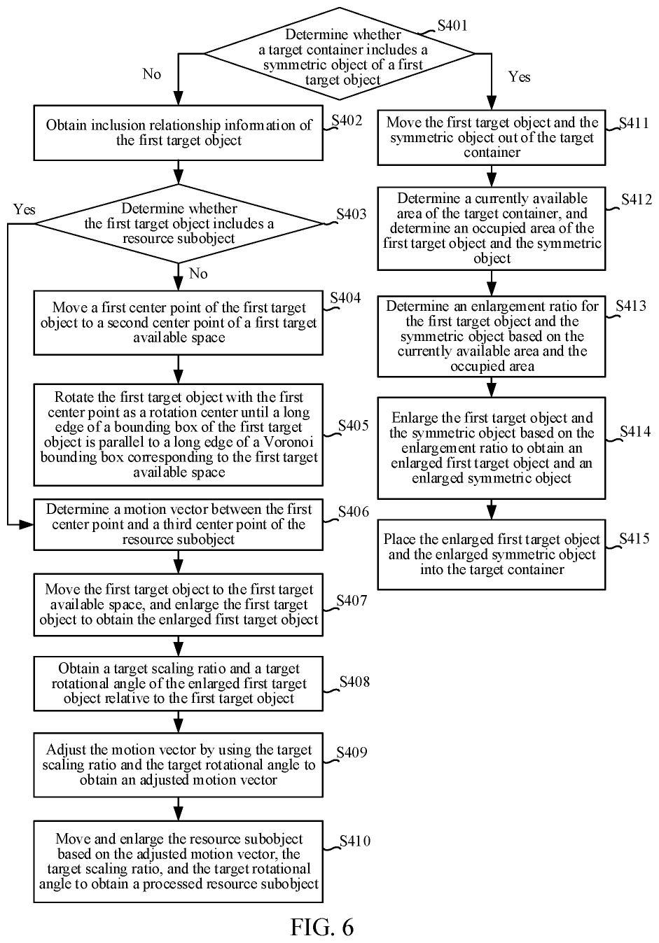

In some aspects, the “moving the first target object to the first target available space” in step S103 may be implemented by step S401 to step S405 shown in FIG. 6. The steps are described below with reference to FIG. 6.

Step S401: Determine whether the target container includes a symmetric object of the first target object.

In a case that the target container does not include a symmetric object of the first target object, only the first target object needs to be moved, and in this case, step S402 is performed. In a case that the target container includes a symmetric object of the first target object, the first target object and the symmetric object of the first target object need to be enlarged at a same ratio, and in this case, step S411 is performed.

Step S402: Obtain inclusion relationship information of the first target object.

Step S403: Determine whether the first target object includes a resource subobject.

In a case that the inclusion relationship information represents that the first target object does not include a resource subobject, the first target object may be moved alone, and in this case, step S404 is performed. In a case that the inclusion relationship information represents that the first target object includes a resource subobject, the first target object and the subobject included in the first target object need to be moved, and in this case, step S406 is performed.

Step S404: Move a first center point of the first target object to a second center point of the first target available space.

Step S405: Rotate the first target object with the first center point as a rotation center until a long edge of a bounding box of the first target object is parallel to a long edge of the Voronoi bounding box corresponding to the first target available space.

In a case that the long edge of the bounding box of the first target object is parallel to the long edge of the Voronoi bounding box corresponding to the first target available space, a wide edge of the bounding box of the first target object is also parallel to a short edge of the Voronoi bounding box corresponding to the first target available space. This can ensure that the bounding box of the first target object can fully fall within a range of the Voronoi bounding box corresponding to the first target available space, and therefore can also ensure that the first target object and the bounding box of the first target object can be fully located in the Voronoi bounding box corresponding to the first target available space after the first target object is scaled based on the first scaling ratio.

In this aspect of this disclosure, the initial filling result obtained by packing the plurality of resource objects includes a case in which another resource object is further nested in a resource object, or may include a case in which several resource objects have a symmetric relationship. In this case, there are different processing manners of moving the first target object to the first target available space based on whether the first target object includes another resource subobject and whether there is a resource object symmetric with the first target object. In a case that the first target object includes a subobject and there is a resource object symmetric with the first target object, the following steps shown in FIG. 6 may be further performed after step S103:

Step S406: Determine a motion vector between the first center point and a third center point of the resource subobject.

The third center point may be a center point of the resource subobject. In an example, the motion vector may be obtained by subtracting first center coordinates of the first center point from third center coordinates of the third center point. For example, the first center coordinates are (30, 40), and the third center coordinates are (40, 60). In this case, the motion vector is (10, 20).

Step S407: Move the first target object to the first target available space, and enlarge the first target object to obtain the enlarged first target object.

In the case of moving the first target object to the first target available space, in some aspects, the first center point of the first target object may be first moved to the second center point of the first target available space, and then the first target object is rotated with the first center point as the rotation center until the long edge of the bounding box of the first target object is parallel to the long edge of the Voronoi bounding box corresponding to the first target available space. In the case of enlarging the first target object, the first target object may be enlarged based on the first scaling ratio corresponding to the first target object by using the first center point of the first target object as an enlargement center, to obtain the enlarged first target object.

Step S408: Obtain a target scaling ratio and a target rotational angle of the enlarged first target object relative to the first target object.

Herein, the target scaling ratio is a first scaling ratio of the bounding box of the first target object, and the target rotational angle is a rotational angle by which the first target object is rotated after the first center point of the first target object is moved to the second center point of the first target available space until the long edge of the bounding box of the first target object is parallel to the long edge of the Voronoi bounding box corresponding to the first target available space during implementation of step S407.

Step S409: Adjust the motion vector by using the target scaling ratio and the target rotational angle to obtain an adjusted motion vector.

In some aspects, the motion vector may be enlarged based on the target scaling ratio and then rotated by the target rotational angle to obtain the adjusted motion vector.

For example, it is assumed the motion vector is (10, 20), the target scaling ratio is 1.5, and the target rotational angle is 30°. In this case, the motion vector is first enlarged by 1.5 times to obtain (15, 30), and is then rotated by 30° to obtain an adjusted motion vector (0, 30).

Step S410: Move and enlarge the resource subobject based on the adjusted motion vector, the target scaling ratio, and the target rotational angle to obtain a processed resource subobject.

In some aspects, a center point of the resource subobject may be moved based on the adjusted motion vector. Then the resource subobject is enlarged based on the target scaling ratio. Finally, an enlarged resource subobject is rotated by the target rotational angle with its own center point as a rotation center to obtain the processed resource subobject.

In the foregoing step S406 to step S410, in a case that the first target object includes another resource subobject, after the first target object is moved, the resource subobject included in the first target object can be moved correspondingly based on a relative location relationship between the first target object and the resource subobject and a motion parameter, the target rotational angle, and the target scaling ratio of the first target object, so that the same location relationship can be retained between the first target object and the resource subobject included in the first target object.

In some aspects, in the case of determining that the target container includes a symmetric object of the first target object, the first target object and the symmetric object may be moved and enlarged in the following step S411 to step S415:

Step S411: Move the first target object and the symmetric object out of the target container.

Step S412: Determine a currently available area of the target container, and determine an occupied area (or occupancy area) of the first target object and the symmetric object.

The currently available area of the target container may be a sum of all available areas in the target container. It is assumed that the currently available area of the target container is S₁. Assuming that the first target object has three symmetric objects and an occupied area of the first target object is S₂, an occupied area of the first target object and the symmetric objects is 4S₂.

Step S413: Determine an enlargement ratio for the first target object and the symmetric object based on the currently available area and the occupied area.

Herein, a ratio of the currently available area to the occupied area may be first determined, that is, S₁/4S₂ is determined. The first target object and the symmetric object usually cannot occupy all the currently available area. Therefore, the ratio of the currently available area to the occupied area needs to be further multiplied by a weight value to obtain the enlargement ratio for the first target object and the symmetric object. The weight value may be a real number less than 1. For example, in a case that the ratio of the currently available area to the occupied area is 2 and the weight value is 0.8, the enlargement ratio for the first target object and the symmetric object is 1.6.

Step S414: Enlarge the first target object and the symmetric object based on the enlargement ratio to obtain an enlarged first target object and an enlarged symmetric object.

Step S415: Place the enlarged first target object and the enlarged symmetric object into the target container.

In some aspects, available spaces for placing the enlarged first target object and the enlarged symmetric object may be determined in the target container, and the enlarged first target object and the enlarged symmetric object are sequentially placed in the available spaces. In a case that there is at least one resource object that cannot be placed in the target container, the enlargement ratio may be reduced based on another weight value to obtain an enlargement ratio again. The weight value may be the same as or different from the weight value used in step S413, and the enlargement ratio obtained again is not less than 1.

In the foregoing step S411 to step S415, in a case that the target container includes a symmetric object of the first target object, the first target object and the symmetric object can be enlarged synchronously, to ensure consistency with a resource object symmetric with the first target object.

In some aspects, the “moving and enlarging the resource subobject based on the adjusted motion vector, the target scaling ratio, and the target rotational angle to obtain a processed resource subobject” in step S410 may be implemented by the following step S4101 to step S4103. The steps are described below.

Step S4101: Determine a target location of the resource subobject based on a fourth center point of the enlarged first target object and the adjusted motion vector.

Herein, fourth center coordinates of the fourth center point may be added to the adjusted motion vector to obtain the target location of the resource subobject. The target location of the resource subobject is a target location of the center point of the resource subobject.

For example, assuming that the fourth center coordinates are (30, 40) and the adjusted motion vector is (0, 30), a center location of the resource subobject is (30, 70).

Step S4102: Move the third center point of the resource subobject to the target location.

Step S4103: Control the resource subobject to rotate by the target rotational angle with the target location as a rotation center, and enlarge the resource subobject based on the target scaling ratio to obtain the processed resource subobject.

In the foregoing step S4101 to step S4103, the resource subobject included in the first target object may be moved into the enlarged first target object, and relative locations of the processed resource subobject and the enlarged first target object can remain unchanged.

The following describes exemplary application of the aspects of this disclosure in a real application scenario.

In the aspects of this disclosure, an object processing method is provided from a perspective of geometry for global packing optimization to meet a specific requirement of a variable-size two-dimensional packing problem such as 2UV unwrapping. The object processing method provided in the aspects of this disclosure may be applied to an automatic 2UV unwrapping tool to implement automated 2UV unwrapping for various game scene models with a baking requirement, including a character model, a vehicle model, a building model, and the like. In some aspects, a terminal displays a model selection interface in response to an operation instruction for “Model import” in the automatic 2UV unwrapping tool, and determines data of target three-dimensional model based on a model selection operation received on the model selection interface. The terminal performs patch triangulation on the target three-dimensional model by using the automatic 2UV tool in response to a received UV unwrapping operation instruction, to obtain a plurality of two-dimensional UV islands. Then the terminal packs the plurality of UV islands to obtain an initial packing result, enlarges and optimizes locations of the plurality of UV islands in the initial packing result in an approximately uniform manner by using a global optimization method based on a polygonal Voronoi diagram, and displays a final packing result. This can minimize an available space to increase a filling rate of a target container. Then the terminal maps the three-dimensional model by using the final packing result. During implementation, the terminal determines a target UV island for mapping in response to a received UV island selection instruction, and the terminal displays a plurality of candidate map images of the target UV island in response to a mapping operation for the target UV island. Then the terminal receives a map selection operation, determines a target map image based on the map selection operation, and maps the target UV island based on the target map image. The UV islands are enlarged during packing. Therefore, a resolution of texture mapping can be increased in the case of mapping the UV islands in the three-dimensional model, to improve authenticity of the three-dimensional model.

The object processing method provided in the aspects of this disclosure is divided into two steps: 1. Pre-calculate UV island features. 2. Iteratively move a UV island. This is separately described below.

### 1. Pre-Calculate UV Island Features.

In the aspects of this disclosure, UV island (corresponding to a resource object in other aspects) features that need to be pre-calculated and saved include the following two types:

### (1) Mutual Inclusion Relationship Between UV Islands

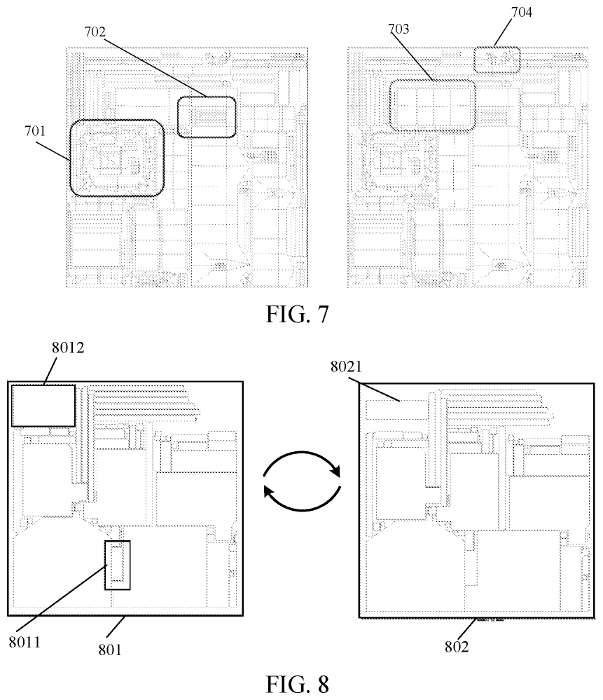

In a packing problem for some applications, a packing result allows some UV islands to be located in holes of some other UV islands. As shown in regions 701 and 702 in FIG. 7, the larger region 701 shows a large UV island including other UV islands, and the smaller region 702 shows a UV island that does not include other UV islands.

Therefore, an inclusion relationship between different UV islands may be pre-determined before packing optimization. An objective of determining this feature is as follows: In a case that a large UV island including another UV island needs to undergo a location update and be enlarged, the UV island included in the large UV island may also synchronously undergo a location update and be enlarged. In this way, a plurality of UV islands can be simultaneously moved each time a largest gap is calculated, to improve efficiency of an algorithm.

Assuming that there are UV islands A and B, a method for calculating whether the UV island A is included in the UV island B may be implemented by the following step S601 to step S603:

Step S601: Perform step S712 or each hole H of the UV island B.

Step S602: Randomly select a point P on an outer boundary of the UV island A, check whether P is located in the hole H by using a library function provided by the CGAL, and in the case of yes, return Yes and end the algorithm.

Step S603: In a case that the point P is located in none of holes, return No.

### (2) Horizontal and Vertical Classification (Corresponding to Attitude Information of a Resource Object in Other Aspects) of a UV Island

In a packing problem for some applications, horizontal and vertical characteristics of some UV islands usually need to be retained during location optimization. In this case, a UV island mainly including horizontal and vertical segments is allowed to rotate only by an integer multiple of 90° during location optimization. Therefore, horizontal and vertical classification of a UV island needs to be pre-calculated and saved for subsequently determining a rotational angle by an algorithm. For example, the region 703 shown in FIG. 7 includes a UV island that is mainly horizontal and vertical (this characteristic needs to be retained during location optimization), and the region 704 includes a UV island that is not mainly horizontal and vertical (this characteristic does not need to be retained during location optimization, and therefore the UV island may rotate by any angle).

Horizontal and vertical classification of a UV island may be calculated by using the following step S711 to step S714:

Step S711: Extract an outer boundary of the UV island and segments on all holes, and denote a set thereof as S.

Step S712: Initialize a length of horizontal and vertical edges to L₁ and a total length of edges to L.

To be specific, lengths of L₁ and L are initialized to 0.

Step S713: Calculate a length l of each segment in the set S, and perform the following update: L=L+l. In a case that the segment is also parallel to an x-axis or a y-axis, perform the following update: L₁=L₁+l.

Step S714: In a case that L₁/L>60%, it is determined that the UV island belongs to a horizontal and vertical type; otherwise, it is determined that the UV island belongs to a non-horizontal-and-vertical type.

### 2. Iteratively Move a UV Island.

After features of all UV islands are pre-calculated and a result is saved, a UV island is iteratively moved. An idea is to iteratively perform the following two steps for a given packing result:
(1) Calculate a largest gap in the current packing result.
(2) Find an optimal candidate UV island that can be placed in the gap, move the UV island to the gap, and appropriately enlarge the UV island.

FIG. 8 shows an overall process of algorithm execution. In a diagram 801 on the left of FIG. 8, a largest gap in a current texture space is first calculated, as indicated by a rectangular region 8012 in an upper left corner of the diagram 801 on the left of FIG. 8. Then an optimal UV island that can be placed in the gap is found from all UV islands, as indicated by a UV island included in a rectangular region 8011 in the diagram 801 on the left of FIG. 8. Then the UV island is moved to the largest gap. Finally, the UV island is enlarged at an appropriate ratio, as indicated by 8021 in a diagram 802 on the right of FIG. 8, so that the UV island fully fills the largest gap in a specific direction. The foregoing steps are iteratively performed until no gap capable of accommodating an existing UV island can be found. The two steps are separately described below.

### (1) Calculate a Largest Gap in the Current Packing Result.

An objective of calculating the largest gap is to find an optimal move-to destination for a UV island in the packing result. A trend of a spatial location can be well approximated based on a polygonal Voronoi diagram. Therefore, in the aspects of this disclosure, a maximum extensible OBB may be calculated based on segments in the polygonal Voronoi diagram, and then the maximum extensible OBB is used as the largest gap. During practical implementation, this may be implemented by the following step S811 to step S814:

Step S811: Calculate an outer contour of a UV island.

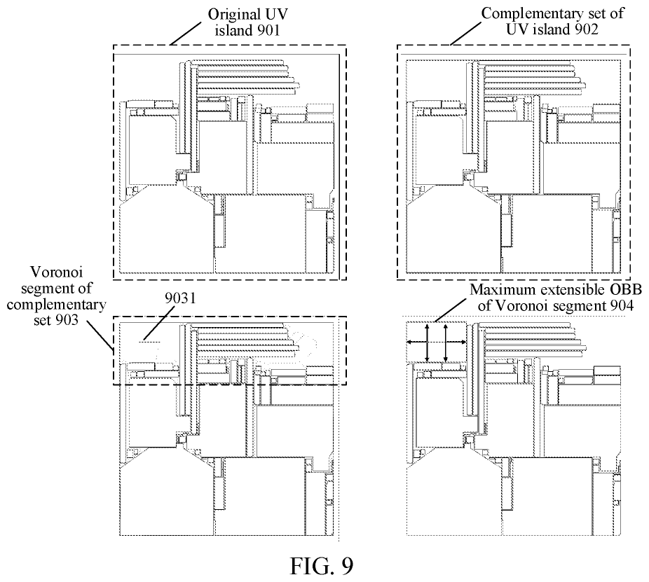

As shown in 901 in FIG. 9, because packing optimization involves only an outer contour of a UV island, outer contours of UV islands are first extracted to reduce an amount of subsequent calculation.

During implementation, an outer contour of a UV island may be extracted as follows: For each edge of the UV island, in a case that all regions adjacent to the edge are located inside the UV island, the edge is marked as an inner edge; otherwise, the edge is marked as an outer edge. All outer edges are connected to form the outer contour of the UV island.

Step S812: Calculate a complementary set of the outer contour relative to the texture space.

During implementation, complementary sets of outer contours of all UV islands relative to the texture space, namely, a universal set, may be calculated by using a library function provided by the CGAL, as shown in 902 in FIG. 9.

Step S813: Calculate a Voronoi diagram of a complementary space, and obtain all segments in the Voronoi diagram.

The Voronoi diagram corresponding to the complementary space may be calculated by using a library function provided by the CGAL. FIG. 9 shows only Voronoi segments in an upper half, as indicated by light gray segments in a dashed-line box 903 in FIG. 9.

Step S814: Calculate a maximum extensible OBB corresponding to each segment.

To improve efficiency, during implementation, the maximum extensible OBB corresponding to each segment in step S813 may be calculated by using a spatial search tree method. A rectangular region 904 in FIG. 9 is a maximum extensible OBB corresponding to a horizontal Voronoi segment 9031 in the figure.

In an example, a maximum extensible OBB corresponding to a Voronoi segment may be determined by using the following steps:

Step S901: Respectively emit rays upward and downward along a direction perpendicular to a current Voronoi segment S, and then respectively calculate shortest intersection points of an upward ray and a downward ray, and record distances a and b from the intersection points to S.

Step S902: Determine a segment T that passes through a midpoint of S, is perpendicular to S, and has an upward length a and a downward length b.

Step S903: Respectively emit rays to the left and to the right along a direction perpendicular to the segment T (namely, a direction of a straight line to which S belongs), and then calculate shortest intersection points of the two rays, and record distances c and d from the intersection points to T.

Step S904: Construct a rectangle with a length a in an up direction, a length b in a down direction, a length c in a left direction, and a length d in a right direction based on the midpoint of S, the rectangle being a maximum extensible OBB corresponding to the current segment S.

### (2) Move a Most Suitable UV Island.

After the largest gap is determined, there are usually a plurality of UV islands that can be moved to the location. In the case of determining a most suitable UV island, the following principles of packing optimization need to be followed:
Principle 1: A large gap is preferentially filled.
Principle 2: The plurality of UV islands are enlarged as uniformly as possible, to avoid a problem that a few UV islands are enlarged at a large ratio and consequently, sizes of most UV islands remain unchanged.
Principle 3: A horizontal and vertical characteristic of a UV island that is mainly horizontal and vertical is not damaged during movement.

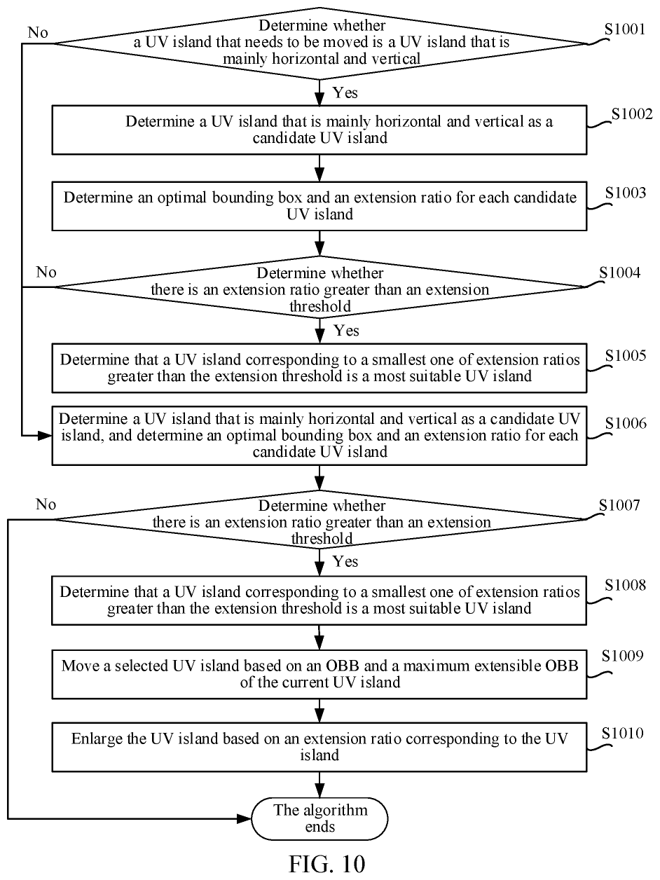

According to the foregoing principles, a most suitable UV island may be selected by using step S1001 to step S1010 shown in FIG. 10. The steps are described below with reference to FIG. 10.

Step S1001: Determine whether a UV island that needs to be moved is a UV island that is mainly horizontal and vertical.

During implementation, whether the UV island that needs to be moved is a UV island that is mainly horizontal and vertical is determined based on whether a current maximum extensible OBB is horizontal and vertical. To be specific, in a case that the current maximum extensible OBB is horizontal and vertical, the UV island that needs to be moved is a UV island that is mainly horizontal and vertical, and in this case, step S1002 is performed; otherwise, it indicates that the UV island that needs to be moved is not a UV island that is mainly horizontal and vertical, and in this case, step S1006 is performed.

Step S1002: Determine a UV island that is mainly horizontal and vertical as a candidate UV island.

Step S1003: Determine an optimal bounding box and an extension ratio for each candidate UV island.

During implementation, an optimal bounding box (OBB) of a candidate UV island may be calculated by using a library function provided by the CGAL. Then a largest ratio at which the optimal bounding box can be extended in a case that the candidate UV island is moved to a current largest gap is determined, and the ratio is determined as an extension ratio of the UV island.

Step S1004: Determine whether there is an extension ratio greater than an extension threshold.

In a case that there is an extension ratio greater than the extension threshold, step S1005 is performed. In a case that there is no extension ratio greater than the extension threshold, step S1006 is performed.

Step S1005: Determine that a UV island corresponding to a smallest one of extension ratios greater than the extension threshold is a most suitable UV island.

In this step, the smallest one of the extension ratios greater than the extension threshold is selected mainly for two reasons: (1) Only a UV island whose extension ratio is greater than the extension threshold is moved to prevent an algorithm from falling into a dead loop or running at excessively low efficiency. In practice, a default value of the extension threshold may be set to 1.2. This can achieve a good balance between efficiency and effectiveness. (2) A smallest extension ratio is selected from all extension ratios greater than the extension threshold to enlarge the plurality of UV islands as uniformly as possible during location optimization, and avoid a problem that a few UV islands are enlarged at a large ratio and consequently, sizes of most UV islands remain unchanged.

Step S1006: Determine a UV island that is mainly horizontal and vertical as a candidate UV island, and determine an optimal bounding box and an extension ratio for each candidate UV island.

In this aspect of this disclosure, in a case that the current maximum extensible OBB corresponding to the largest gap is horizontal and vertical and there is no UV island whose extension ratio is greater than the extension threshold among horizontal and vertical UV islands, a most suitable UV island may be re-selected from all UV islands belonging to the non-horizontal-and-vertical type to maximize optimization effect. However, this process is unidirectional, and a horizontal and vertical UV island cannot be placed in a non-horizontal-and-vertical maximum extensible OBB, because this damages the original horizontal and vertical characteristic of the UV island.

Step S1007: Determine whether there is an extension ratio greater than an extension threshold.

In a case that there is an extension ratio greater than the extension threshold, step S1008 is performed. In a case that there is no extension ratio greater than the extension threshold, the process ends.

Step S1008: Determine that a UV island corresponding to a smallest one of extension ratios greater than the extension threshold is a most suitable UV island.

Step S1009: Move a selected UV island based on an OBB and a maximum extensible OBB of the current UV island.

During implementation, the UV island is first moved so that a center point of the UV island coincides with a center point of the maximum extensible OBB, and then the UV island is rotated so that a long edge of the optimal bounding box of the UV island is parallel to a long edge of the maximum extensible OBB.

Step S1010: Enlarge the UV island based on an extension ratio corresponding to the UV island.

In addition, a practical 2UV unwrapping project usually include one or more groups of symmetric UV islands. Sometimes, a user expects to retain sizes of these symmetric UV islands during packing. In this case, UV islands may be moved by using the following steps, to fully enlarge asymmetric UV islands while synchronously enlarging or retaining original sizes of the symmetric UV islands.

Step S1101: Calculate all gaps in the current packing result and a largest gap among them. In a case that a result is empty, the algorithm ends.

Step S1102: Calculate a UV island most suitable for movement, and denote the UV island as I. In a case that no UV island is found, the algorithm ends.

Step S1103: In a case that I is an asymmetric UV island, optimize a location of I according to the solution shown in FIG. 10 until a largest gap is determined, and proceed to step S1101.

Step S1104: In a case that I is a symmetric UV island, extract all UV islands from a symmetric group to which I belongs, and then pack the UV islands into all gaps determined by using a packing method provided by a Nest tool, and proceed to step S1101.

In the solution shown in step S1101 to step S1104, after a to-be-moved UV island is determined, whether the UV island is a symmetric UV island or an asymmetric UV island is first determined, and then different location optimization and size enlargement policies are used based on a determining result. In step S1104, all symmetric UV islands in one group are repacked by using a uniform scaling ratio. Therefore, the symmetric UV islands can be synchronously enlarged at a maximum ratio within a region available for placement. This means that the symmetric UV islands are extended to the maximum extent while ensuring a uniform size.

To verify performance improvement of the 2UV unwrapping tool according to the object processing method proposed in the aspects of this disclosure, batch tests are performed on art resources for 14 projects (A, B, . . . , and N), and statistical results shown in Table 1 are obtained.

TABLE 1
Statistical comparison with beneficial effect of the object
processing method provided in the aspects of this disclosure

| | Art resources | | | | | | |
|---|---|---|---|---|---|---|---|
| Indicator | A | B | C | D | E | F | G |
| Total number of resources | 1440 | 851 | 138 | 388 | 46 | 449 | 197 |
| Filling rate before optimization | 0.63 | 0.61 | 0.60 | 0.64 | 0.62 | 0.65 | 0.62 |
| Filling rate after optimization | 0.64 | 0.64 | 0.62 | 0.66 | 0.64 | 0.70 | 0.67 |
| Improvement ratio | 0.01 | 0.03 | 0.02 | 0.02 | 0.02 | 0.05 | 0.05 |
| | H | I | J | K | L | M | N |
| Total number of resources | 50 | 77 | 450 | 789 | 219 | 48 | 17 |
| Filling rate before optimization | 0.64 | 0.58 | 0.60 | 0.64 | 0.67 | 0.56 | 0.58 |
| Filling rate after optimization | 0.67 | 0.63 | 0.64 | 0.68 | 0.70 | 0.62 | 0.60 |
| Improvement ratio | 0.03 | 0.05 | 0.04 | 0.04 | 0.03 | 0.06 | 0.02 |

In Table 1, through comparison between an average filling rate of a packing tool without location optimization and that of the packing tool with location optimization, it is found that the filling rate of the packing tool can be increased to different degrees after global location optimization is performed (in other words, the object processing method provided in the aspects of this disclosure is applied). On average, in the global packing optimization method, the filling rate can be increased by approximately 5%, and a ratio by which the packing tool surpasses manual packing can be increased by approximately 10%.

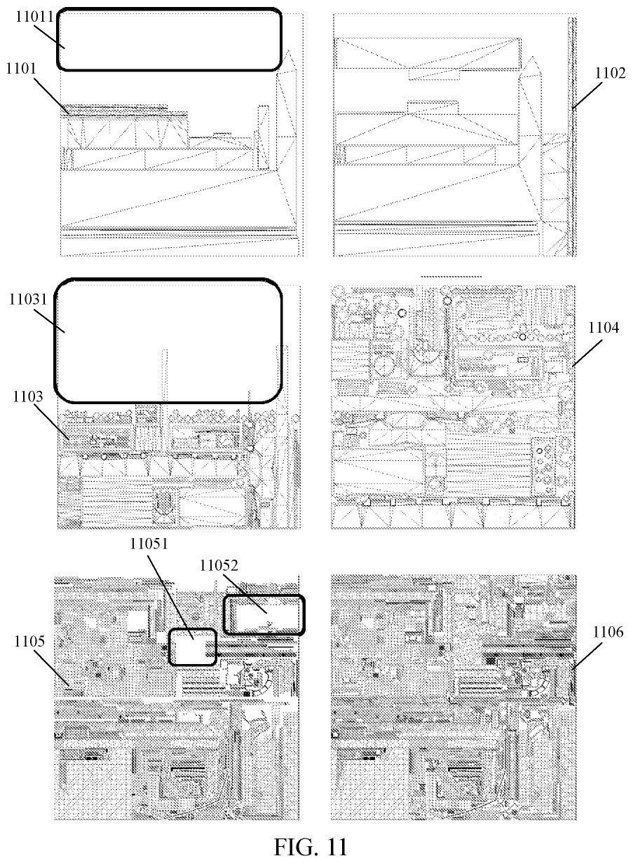

FIG. 11 shows optimization results of object enlargement according to an aspect of this disclosure. 1101, 1103, and 1105 in FIG. 11 are schematic diagrams of packing results obtained without optimization by using the object processing method provided in the aspects of this disclosure. 1102, 1104, and 1106 in FIG. 11 show packing results obtained after global optimization is performed by using the object processing method provided in the aspects of this disclosure. It can be learned through comparison that, in the object processing method provided in the aspects of this disclosure, in comparison diagrams at each row, a large gap shown on the left (a rectangular-box region 11011 in 1101, a rectangular-box region 11031 in 1103, and rectangular-box regions 11051 and 11052 in 1105) is filled on the right, without distorting a UV island. This significantly increases a filling rate.

The following further describes an exemplary structure of an object processing apparatus 455 provided in the aspects of this disclosure when the apparatus is implemented as software modules. In some aspects, as shown in FIG. 3, software modules of the object processing apparatus 455 that are stored in a memory 450 may include:
an object filling module 4551, configured to place a plurality of to-be-processed resource objects into a target container to obtain an initial filling result; a first determining module 4552, configured to determine a first target available space in the target container based on the initial filling result, and determine a first target object from the plurality of resource objects based on the first target available space; a first enlarging module 4553, configured to move the first target object to the first target available space, and enlarge the first target object based on the first target available space to obtain an enlarged first target object; and a second determining module 4554, configured to determine a second target available space and a second target object in the target container until no movable target object can be determined from the plurality of resource objects.

In some aspects, the first determining module 4552 is further configured to: obtain outer boundary information of the plurality of resource objects, and determine a complementary space of the outer boundary information of the plurality of resource objects relative to the target container based on the initial filling result; determine a Voronoi diagram of the complementary space, and obtain Voronoi segments in the Voronoi diagram; determine Voronoi bounding boxes corresponding to the Voronoi segments; and determine a Voronoi bounding box with a largest area as the first target available space in the target container.

In some aspects, the first determining module is further configured to: determine attitude information of a Voronoi bounding box corresponding to the first target available space; in a case that the attitude information represents that the Voronoi bounding box is in a first attitude, and it is determined that the plurality of resource objects include at least one first candidate object in the first attitude, determine a first candidate bounding box for each first candidate object, and determine a first scaling ratio corresponding to each first candidate bounding box based on the Voronoi bounding box; and in a case that there is at least one first candidate scaling ratio greater than a preset ratio threshold, determine a first candidate object corresponding to a smallest scaling ratio of the first candidate scaling ratio as the first target object.

In some aspects, the apparatus further includes: a second determining module, configured to: in a case that the attitude information represents that the Voronoi bounding box is in a second attitude, or there is no first candidate object, or there is no candidate scaling ratio greater than the ratio threshold, determine a second candidate object in the second attitude from the plurality of resource objects; a third determining module, configured to determine a second candidate bounding box for each second candidate object, and determine a second scaling ratio corresponding to each second candidate bounding box based on the Voronoi bounding box; and a fourth determining module, configured to: in a case that there is at least one second candidate scaling ratio greater than the preset ratio threshold, determine a second candidate object corresponding to a smallest scaling ratio of the second candidate scaling ratio as the first target object.

In some aspects, the first determining module is further configured to: obtain first coordinate information of a first endpoint of a Voronoi segment corresponding to the Voronoi bounding box and second coordinate information of a second endpoint; determine, based on the first coordinate information and the second coordinate information, a first coordinate difference between the first endpoint and the second endpoint in a horizontal direction, and determine a second coordinate difference between the first endpoint and the second endpoint in a vertical direction; and in a case that the first coordinate difference is less than a preset difference threshold, or the second coordinate difference is less than the difference threshold, determine that the attitude information of the Voronoi bounding box is the Voronoi bounding box being in the first attitude; or in a case that the first coordinate difference is not less than the difference threshold, and the second coordinate difference is not less than the difference threshold, determine that the attitude information of the Voronoi bounding box is the Voronoi bounding box being in the second attitude.

In some aspects, the apparatus further includes: a first obtaining module, configured to obtain attitude information and inclusion relationship information of resource objects; and a fifth determining module, configured to determine, based on the attitude information and the inclusion information of the resource objects, whether the plurality of resource objects include a first candidate object that is in the first attitude and that is not included in other resource objects.

In some aspects, the first determining module is further configured to: obtain a first length and a first width of the Voronoi bounding box, and obtain a second length and a second width of the first candidate bounding box; determine a quotient of the first length and the second length as a length scaling ratio; determine a quotient of the first width and the second width as a width scaling ratio; and determine a smaller one of the length scaling ratio and the width scaling ratio as the first scaling ratio corresponding to the first candidate bounding box.

In some aspects, the first enlarging module is further configured to: obtain inclusion relationship information of the first target object in the case of determining that the target container does not include a symmetric object of the first target object; move a first center point of the first target object to a second center point of the first target available space in a case that the inclusion relationship information represents that the first target object does not include a resource subobject; and rotate the first target object with the first center point as a rotation center until a long edge of a bounding box of the first target object is parallel to a long edge of the Voronoi bounding box corresponding to the first target available space.

In some aspects, the apparatus further includes: a sixth determining module, configured to: in a case that the inclusion relationship information represents that the first target object includes a resource subobject, determine a motion vector between the first center point and a third center point of the resource subobject; a second enlarging module, configured to move the first target object to the first target available space, and enlarge the first target object to obtain the enlarged first target object;
a second obtaining module, configured to obtain a target scaling ratio and a target rotational angle of the enlarged first target object relative to the first target object; a first adjustment module, configured to adjust the motion vector by using the target scaling ratio and the target rotational angle to obtain an adjusted motion vector; and a third enlarging module, configured to move and enlarge the resource subobject based on the adjusted motion vector, the target scaling ratio, and the target rotational angle to obtain a processed resource subobject.

In some aspects, the third enlarging module is further configured to: determine a target location of the resource subobject based on a fourth center point of the enlarged first target object and the adjusted motion vector; move the third center point of the resource subobject to the target location; and control the resource subobject to rotate by the target rotational angle with the target location as a rotation center, and enlarge the resource subobject based on the target scaling ratio to obtain the processed resource subobject.

In some aspects, the apparatus further includes: an object move-out module, configured to: in the case of determining that the target container includes a symmetric object of the first target object, move the first target object and the symmetric object out of the target container; a sixth determining module, configured to determine a currently available area of the target container, and determine an occupied area of the first target object and the symmetric object; a seventh determining module, configured to determine an enlargement ratio for the first target object and the symmetric object based on the currently available area and the occupied area;
a fourth enlarging module, configured to enlarge the first target object and the symmetric object based on the enlargement ratio to obtain an enlarged first target object and an enlarged symmetric object; and an object placing module, configured to place the enlarged first target object and the enlarged symmetric object into the target container.

In some aspects, the apparatus further includes: a third obtaining module, configured to obtain information of holes of an i^{th} resource object, i=1, 2, . . . , N, and N being the total number of resource objects; an eighth determining module, configured to randomly determine a reference point from an outer boundary of a j^{th} resource object, and determine whether the reference point is located in a hole of the i^{th} resource object, j=1, 2, . . . , N, and i being not equal to j; an information update module, configured to: in a case that the reference point is located in a hole of the i^{th} resource object, determine that the i^{th} resource object includes the j^{th} resource object, and update inclusion relationship information of the i^{th} resource object and the j^{th} resource object; and a ninth determining module, configured to: in a case that the reference point is not located in a hole of the i^{th} resource object, determine that the i^{th} resource object does not include the j^{th} resource object.

In some aspects, the apparatus further includes: a fourth obtaining module, configured to obtain segments included in an i^{th} resource object and lengths of the segments; a tenth determining module, configured to determine a target segment based on endpoint information of the segments, a first coordinate difference between two endpoints of the target segment in the horizontal direction being less than a preset difference threshold, or a second coordinate difference between the two endpoints of the target segment in the vertical direction being less than the difference threshold; an eleventh determining module, configured to determine a first total length of the i^{th} resource object based on the lengths of the segments; a twelfth determining module, configured to determine a second total length of the i^{th} resource object based on a length of the target segment; and a thirteenth determining module, configured to: in a case that a ratio of the second total length to the first total length is greater than a preset ratio threshold, determine that attitude information of the i^{th} resource object is the first attitude.

The descriptions of the object processing apparatus in this aspect of this disclosure are similar to the descriptions of the foregoing method aspects, and the apparatus has beneficial effect similar to that of the method aspects. For technical details not disclosed in this apparatus aspect, refer to the descriptions of the method aspects of this disclosure for understanding.

An aspect of this disclosure provides a computer program product or a computer program. The computer program product or the computer program includes computer instructions, and the computer instructions are stored in a non-transitory computer-readable storage medium. A processor of a computer device reads the computer instructions from the computer-readable storage medium, and the processor executes the computer instructions, so that the computer device performs the object processing method in the aspects of this disclosure.

An aspect of this disclosure provides a computer-readable storage medium, having executable instructions stored therein. When the executable instructions are executed by a processor, the processor is enabled to perform the object processing method provided in the aspects of this disclosure, for example, the object processing method shown in FIG. 4, FIG. 5, or FIG. 6.

In some aspects, the computer-readable storage medium may be a memory such as a FRAM, a ROM, a PROM, an EPROM, an EEPROM, a flash memory, a magnetic surface memory, a compact disc, or a CD-ROM; or may be various devices including one of or any combination of the foregoing memories.

In some aspects, the executable instructions may be written in a form of a program, software, a software module, a script, or code based on a programming language in any form (including a compiled or interpretive language, or a declarative or procedural language), and may be deployed in any form, including being deployed as a standalone program, or being deployed as a module, a component, a subroutine, or another unit suitable for use in a computing environment.

In an example, the executable instructions may, but not necessarily, correspond to a file in a file system, and may be stored as a part of a file that stores other programs or data, for example, stored in one or more scripts of a Hypertext Markup Language (HTML) document, stored in a single file dedicated for the discussed program, or stored in a plurality of co-files (for example, files that store one or more modules, subroutines, or code parts).

In an example, the executable instructions may be deployed on one computing device for execution, or may be executed on a plurality of computing devices at one location, or may be executed on a plurality of computing devices that are distributed at a plurality of locations and that are interconnected through a communication network.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing disclosure includes some exemplary embodiments of this disclosure which are not intended to limit the scope of this disclosure. Other embodiments shall also fall within the scope of this disclosure.

What is claimed is:

1. An object processing method, comprising:
placing a plurality of objects into a container according to an initial packing algorithm to obtain an initial filling result, wherein the objects and the container are two-dimensional polygons;
determining a first available space in the container based on the initial filling result, and selecting a first object from the plurality of objects based on the first available space;
moving the first object to the first available space, and enlarging the first object based on the first available space to obtain an enlarged first object; and
iteratively performing the determining the first available space, the selecting the first object, the moving the first object, and the enlarging the first object until no movable object can be selected from the plurality of objects to generate a repacked container.

2. The method according to claim 1, wherein the determining the first available space in the container based on the initial filling result comprises:
obtaining outer boundary information of the plurality of objects, and determining a complementary space of the outer boundary information of the plurality of objects relative to the container based on the initial filling result;
determining a Voronoi diagram of the complementary space, and obtaining Voronoi segments in the Voronoi diagram;
determining Voronoi bounding boxes corresponding to the Voronoi segments; and
determining a Voronoi bounding box with a largest area as the first available space in the container.

3. The method according to claim 2, wherein the determining the first object from the plurality of objects based on the first available space comprises:
determining attitude information of a Voronoi bounding box corresponding to the first available space;
in a case that the attitude information of the Voronoi bounding box indicates a first attitude, and the plurality of objects comprise at least one first candidate object in the first attitude, determining a first candidate bounding box for each first candidate object, and determining a first scaling ratio corresponding to each first candidate bounding box based on the Voronoi bounding box; and
in a case that there is at least one first candidate scaling ratio greater than a preset ratio threshold, determining a first candidate object corresponding to a smallest scaling ratio among the at least one first candidate scaling ratio as the first object.

4. The method according to claim 3, wherein the method further comprises:
in a case that the attitude information of the Voronoi bounding box indicates a second attitude, or there is no first candidate object in the first attitude, or there is no first candidate scaling ratio greater than the ratio threshold, determining at least one second candidate object in the second attitude from the plurality of objects;
determining a second candidate bounding box for each second candidate object, and determining a second scaling ratio corresponding to each second candidate bounding box based on the Voronoi bounding box; and
in a case that there is at least one second candidate scaling ratio greater than the preset ratio threshold, determining a second candidate object corresponding to a smallest scaling ratio among the at least one second candidate scaling ratio as the first object.

5. The method according to claim 3, wherein the determining the attitude information of the Voronoi bounding box corresponding to the first available space comprises:
obtaining first coordinate information of a first endpoint of a Voronoi segment corresponding to the Voronoi bounding box and second coordinate information of a second endpoint;
determining, based on the first coordinate information and the second coordinate information, a first coordinate difference between the first endpoint and the second endpoint in a horizontal direction, and determining a second coordinate difference between the first endpoint and the second endpoint in a vertical direction; and
in a case that the first coordinate difference is less than a preset difference threshold, or the second coordinate difference is less than the difference threshold, determining that the attitude information of the Voronoi bounding box indicates the first attitude; or
in a case that the first coordinate difference is greater than or equal to the difference threshold, and the second coordinate difference is greater than or equal to the difference threshold, determining that the attitude information of the Voronoi bounding box indicates the second attitude.

6. The method according to claim 3, wherein the method further comprises:
obtaining attitude information and inclusion relationship information of the plurality of objects in a case that the attitude information of the Voronoi bounding box indicates the first attitude; and
determining, based on the attitude information and the inclusion relationship information of the plurality of objects, whether the plurality of objects comprise a first candidate object that is in the first attitude and that is not comprised in other objects.

7. The method according to claim 3, wherein the determining the first scaling ratio corresponding to each first candidate bounding box based on the Voronoi bounding box comprises:
obtaining a first length and a first width of the Voronoi bounding box, and obtaining a second length and a second width of the respective first candidate bounding box;
determining a quotient of the first length and the second length as a length scaling ratio;
determining a quotient of the first width and the second width as a width scaling ratio; and
determining a smaller one of the length scaling ratio and the width scaling ratio as the first scaling ratio corresponding to the respective first candidate bounding box.

8. The method according to claim 3, wherein the moving the first object to the first available space comprises:
obtaining inclusion relationship information of the first object in a case that the container does not comprise a symmetric object of the first object;
moving a first center point of the first object to a second center point of the first available space in a case that the inclusion relationship information indicates that the first object does not comprise a sub-object; and
rotating the first object with the first center point as a rotation center until a long edge of a bounding box of the first object is parallel to a long edge of the Voronoi bounding box corresponding to the first available space.

9. The method according to claim 8, wherein the method further comprises:
in a case that the inclusion relationship information represents that the first object comprises a sub-object, determining a motion vector between the first center point and a third center point of the sub-object;
moving the first object to the first available space, and enlarging the first object to obtain the enlarged first object;
obtaining a scaling ratio and a rotational angle of the enlarged first object relative to the first object;
adjusting the motion vector by using the scaling ratio and the rotational angle to obtain an adjusted motion vector; and
moving and enlarging the sub-object based on the adjusted motion vector, the scaling ratio, and the rotational angle to obtain a processed sub-object.

10. The method according to claim 9, wherein the moving and enlarging the sub-object comprises:
determining a location of the sub-object based on a fourth center point of the enlarged first object and the adjusted motion vector;
moving the third center point of the sub-object to the location; and
controlling the sub-object to rotate by the rotational angle with the location as a rotation center, and enlarging the sub-object based on the scaling ratio to obtain the sub-object.

11. The method according to claim 8, wherein the method further comprises:
in a case that the container comprises a symmetric object of the first object, moving the first object and the symmetric object out of the container;
determining a currently available area of the container, and determining an occupancy area of the first object and the symmetric object;
determining an enlargement ratio for the first object and the symmetric object based on the currently available area and the occupancy area;
enlarging the first object and the symmetric object based on the enlargement ratio to obtain an enlarged first object and an enlarged symmetric object; and
placing the enlarged first object and the enlarged symmetric object into the container.

12. The method according to claim 1, wherein the method further comprises:
obtaining information of holes of an i^{th} object of the plurality of objects, i=1, 2, . . . , N, N being a total number of objects in the plurality of objects, and N being an integer greater than 1;
selecting a reference point from an outer boundary of a j^{th} object of the plurality of objects, and determining whether the reference point is located in a hole of the i^{th} object, j=1, 2, . . . , N, and i being not equal to j; and
in a case that the reference point is located in the hole of the i^{th} object, determining that the i^{th} object comprises the j^{th} object, and updating inclusion relationship information of the i^{th} object and the j^{th} object; or
in a case that the reference point is not located in the hole of the i^{th} object, determining that the i^{th} object does not comprise the j^{th} object.

13. The method according to claim 1, wherein the method further comprises:
obtaining segments comprised in an i^{th} object of the plurality of objects and lengths of the segments;
determining a segment based on endpoint information of the segments, a first coordinate difference between two endpoints of the segment in a horizontal direction being less than a preset difference threshold, or a second coordinate difference between the two endpoints of the segment in a vertical direction being less than the difference threshold;
determining a first total length of the i^{th} object based on the lengths of the segments;
determining a second total length of the i^{th} object based on a length of the determined segment; and
in a case that a ratio of the second total length to the first total length is greater than a preset ratio threshold, determining that attitude information of the i^{th} object is the first attitude.

14. An object processing apparatus, comprising:
processing circuitry configured to
place a plurality of objects into a container according to an initial packing algorithm to obtain an initial filling result, wherein the objects and the container are two-dimensional polygons;
determine a first available space in the container based on the initial filling result, and select a first object from the plurality of objects based on the first available space;
move the first object to the first available space, and enlarge the first object based on the first available space to obtain an enlarged first object; and
iteratively perform the determining the first available space, the selecting the first object, the moving the first object, and the enlarging the first object until no movable object can be selected from the plurality of objects to generate a repacked container.

15. The apparatus according to claim 14, wherein the processing circuitry is further configured to:
obtain outer boundary information of the plurality of objects, and determine a complementary space of the outer boundary information of the plurality of objects relative to the container based on the initial filling result;
determine a Voronoi diagram of the complementary space, and obtaining Voronoi segments in the Voronoi diagram;
determine Voronoi bounding boxes corresponding to the Voronoi segments; and
determine a Voronoi bounding box with a largest area as the first available space in the container.

16. The apparatus according to claim 15, wherein the processing circuitry is further configured to:
determine attitude information of a Voronoi bounding box corresponding to the first available space;
in a case that the attitude information of the Voronoi bounding box indicates a first attitude, and the plurality of objects comprise at least one first candidate object in the first attitude, determine a first candidate bounding box for each first candidate object, and determine a first scaling ratio corresponding to each first candidate bounding box based on the Voronoi bounding box; and
in a case that there is at least one first candidate scaling ratio greater than a preset ratio threshold, determine a first candidate object corresponding to a smallest scaling ratio among the at least one first candidate scaling ratio as the first object.

17. The apparatus according to claim 16, wherein the processing circuitry is further configured to:
in a case that the attitude information of the Voronoi bounding box indicates a second attitude, or there is no first candidate object in the first attitude, or there is no first candidate scaling ratio greater than the ratio threshold, determine at least one second candidate object in the second attitude from the plurality of objects;
determine a second candidate bounding box for each second candidate object, and determine a second scaling ratio corresponding to each second candidate bounding box based on the Voronoi bounding box; and
in a case that there is at least one second candidate scaling ratio greater than the preset ratio threshold, determine a second candidate object corresponding to a smallest scaling ratio among the at least one second candidate scaling ratio as the first object.

18. The apparatus according to claim 16, wherein the processing circuitry is further configured to:
obtain first coordinate information of a first endpoint of a Voronoi segment corresponding to the Voronoi bounding box and second coordinate information of a second endpoint;
determine, based on the first coordinate information and the second coordinate information, a first coordinate difference between the first endpoint and the second endpoint in a horizontal direction, and determining a second coordinate difference between the first endpoint and the second endpoint in a vertical direction; and
in a case that the first coordinate difference is less than a preset difference threshold, or the second coordinate difference is less than the difference threshold, determine that the attitude information of the Voronoi bounding box indicates the first attitude; or
in a case that the first coordinate difference is greater than or equal to the difference threshold, and the second coordinate difference is greater than or equal to the difference threshold, determine that the attitude information of the Voronoi bounding box indicates the second attitude.

19. The apparatus according to claim 16, wherein the processing circuitry is further configured to:
obtain attitude information and inclusion relationship information of the plurality of objects in a case that the attitude information of the Voronoi bounding box indicates the first attitude; and
determine, based on the attitude information and the inclusion relationship information of the plurality of objects, whether the plurality of objects comprise a first candidate object that is in the first attitude and that is not comprised in other objects.

20. A non-transitory computer-readable storage medium storing computer-readable instructions thereon, which, when executed by processing circuitry, cause the processing circuitry to perform an object processing method comprising:
placing a plurality of objects into a container according to an initial packing algorithm to obtain an initial filling result, wherein the objects and the container are two-dimensional polygons;
determining a first available space in the container based on the initial filling result, and selecting a first object from the plurality of objects based on the first available space;
moving the first object to the first available space, and enlarging the first object based on the first available space to obtain an enlarged first object; and
iteratively performing the determining the first available space, the selecting the first object, the moving the first object, and the enlarging the first object until no movable object can be selected from the plurality of objects to generate a repacked container.
